(19) United States
(12) Patent Application Publication
(10) Pub. No.: US 2009/0052482 A1
(43) Pub. Date: Feb. 26, 2009

(54) COOLING AN ACTIVE MEDIUM USING RAMAN SCATTERING

(76) Inventors: Nathalie Vermeulen, Lint (BE); Peter Muys, Genf (BE); Christof Debaes, Lot (BE); Hugo Thienpont, Gooik (BE)

Correspondence Address: BACON & THOMAS, PLLC, 625 SLATERS LANE, FOURTH FLOOR, ALEXANDRIA, VA, 22314-1176, US

(21) Appl. No.: 12/282,267

(22) PCT Filed: Mar. 12, 2007
(86) PCT No.: PCT/EP2007/002133

§ 371 Date: Sep. 9, 2008

(30) Foreign Application Priority Data
Mar. 10, 2006 (EP) 06004909.5

(51) Int. Cl. H01S 3/04

(52) U.S. Cl. 372/34

(57) ABSTRACT

A method is described for setting up a system comprising an active medium. The method comprises thermally controlling the system comprising an active medium by radiative cooling. The radiative cooling thereby is based on stimulated and/or coherent Raman scattering processes. In particular embodiments, the thermally controlling may be obtained by tailoring the efficiencies of the Raman scattering processes by optimising at least one of a number of system parameters. The invention furthermore relates to systems thus obtained, to methods for thermally controlling systems comprising an active medium that generate radiation and to computer program products for performing the methods for setting up systems comprising an active medium and thermally controlled by radiative cooling using stimulated and/or coherent Raman scattering processes.

### FIELD OF THE INVENTION

This invention relates to systems comprising an active medium and to methods of operating systems comprising an active medium. More particularly, the invention relates to methods for controlling thermal conditions of an active medium, to methods for designing systems with controlled thermal conditions and to systems with controlled thermal conditions.

### DESCRIPTION OF THE RELATED ART

The process of generating coherent radiation in optically pumped laser systems is never hundred percent effective. It always results in some energy being lost and, consequently, in heat generation. Part of the energy that is pumped into the laser system, is not effectively converted into photons but into phonons, i.e. quanta of vibrational energy inside the active medium. The resulting increase in temperature affects and degrades the laser performance characteristics, such as pump efficiency and the beam quality. For laser systems comprising a solid active medium—in general, these lasers suffer most from unwanted heat generation—this temperature increase induces accelerated aging of the active medium and might even result in catastrophic failure due to overheating and thermal shock. All these problematic consequences of unwanted heat generation inside an active medium indicate why this excessive heat creation represents the most important bottleneck for upscaling the output power of a laser system.

Different architectures have been implemented in the past to cope with this problem. In case of laser systems with a solid medium, for example, most of them rely on water as cooling liquid in a heat sink. The presence of water leads to complicated and delicate mechanical constructions in the pump cavity, since on one hand the outer surface of the active medium needs to remain accessible for the pump radiation to penetrate the medium, and on the other hand this same surface needs to be in thermal contact over an area as large as possible in order to obtain efficient cooling. The compromise between both options is not simple, and moreover, the architecture should be kept as compact as possible to enhance the laser's practical applicability.

Therefore, the thermal management of an optically pumped active medium is the key to success in scaling up the laser's output power on one hand, and in reducing the volume of the laser on the other hand. As a result, the development of an intrinsic cooling mechanism that prohibits the undesired heat generation inside the medium would open up many perspectives in the design of high power, small sized lasers.

With respect to the latter, the idea of using radiative cooling based upon spontaneous anti-Stokes fluorescence emerged already in 1929. To implement this idea, one needs to identify materials with an anti-Stokes shifted fluorescence band, i.e. with a fluorescence spectrum of which the average frequency is higher than the pump frequency. Using the terminology of quantum physics, this radiative cooling mechanism consists of the transformation of a pump photon into a photon with a higher frequency in a host material which provides the energy difference by annihilation of a phonon. The qualification test for this type of cooling is based on photothermal deflection spectroscopy which is capable of detecting a heating or a cooling effect of the incident radiation. The effect has been found already in a number of Yb⁺⁺⁺ and Tm⁺⁺⁺ doped crystals and glasses.

If the fluorescence cooling of an active medium with an anti-Stokes shifted spontaneous fluorescence band just offsets the heat production in the laser action process, then there is no net heat generation inside these media. This principle of ‘radiation balanced lasing’ is illustrated in FIG. 1, which shows absorption and fluorescence spectra indicating the required ordering of the laser frequency v_{L}, the pump frequency v_{P}, and the average fluorescence frequency VF for radiation-balanced lasing, as described by Bowman e.g. in WO 01/48876 A1. A first radiatively cooled laser has recently been demonstrated, exhibiting only 0.42% heat generation in its active medium. This is a first step towards the development of laser devices which can produce higher average output powers without suffering thermal problems or suffering insufficient beam quality. However, since this cooling mechanism can only properly work in case of a large anti-Stokes shift of the fluorescence spectrum with respect to the pump frequency, it can be applied to just a limited number of active media, which include almost no other active media than the Yb- and Tm-doped crystals. Thus, this type of cooling does not have a widespread applicability.

### SUMMARY OF THE INVENTION

It is an object of the invention to provide improved methods for thermally controlling systems comprising an active medium, also referred to as active-medium-based systems, to provide improved active-medium based systems with thermal control and to provide improved methods for designing such active-medium based systems with thermal control. For example, these active-medium-based systems may be laser setups or oscillator setups, but it may also be amplifier setups, generator setups, or converter setups. It is more particularly an object of the present invention to provide improved active-medium-based systems with thermal control and improved methods for thermally controlling active-medium-based systems and for designing such active-medium based systems with thermal control using radiation.

The present invention relates to a method for setting up a system comprising an active medium, the method comprising thermally controlling said system comprising an active medium by radiative cooling based on invoked, i.e. coherent and/or stimulated, Raman scattering processes. It is to be noted that invoked Raman scattering processes are stimulated and/or coherent Raman scattering processes such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes.

The system may be defined by a number of system parameters. Said thermally controlling may comprise tailoring the efficiencies of invoked Raman scattering processes by optimising at least one of said number of system parameters.

Said optimising at least one of said number of system parameters may comprise selecting a parameter value and/or a parameter setting such that the ratio of the number of anti-Stokes Raman scattered photons to the number of Stokes Raman scattered photons is increased. Parameter settings thereby may refer to non-numerical parameter selections such as e.g. Gaussian beam or Bessel beam for the beam profile. Selecting a parameter may be selecting a parameter value and/or a parameter setting such that the ratio of the number of anti-Stokes Raman scattered photons to the number of Stokes Raman Scattered photons may reach a global or local maximum, or substantially a value close to a global or local maximum. Close to a global or local maximum may be within 30%, preferably within 10%, more preferably within 5% of said global or local maximum.

Optimising at least one of said number of system parameters may comprise obtaining a plurality of sets of system parameter values and/or system parameter settings, for each of said plurality of sets of system parameters values and/or system parameter settings, modelling optical processes including invoked Raman scattering processes in the active medium and calculating a number of Stokes- and anti-Stokes-scattered photons generated, evaluating said plurality of calculated numbers of Stokes- and anti-Stokes-scattered photons generated and selecting, based thereon, a set of optimum system parameter values and/or system parameter settings.

Said modelling optical processes may comprise using a model describing a longitudinal variation of forward-propagating and backward-propagating pump, Stokes and anti-Stokes electromagnetic waves in said system and calculating a fraction of said forward- and backward-propagating pump, Stokes and anti-Stokes electromagnetic waves that is coupled out of, e.g. emitted by, said system. Said describing may be performed half roundtrip per half roundtrip. Said calculating may be performed half roundtrip per half roundtrip. Said model may be a continuous-wave or quasi-continuous wave Raman laser model. Said model may be referred to as an iterative resonator model.

Said modelling optical processes may comprise using a model allowing calculating a growth or decrease of Stokes pulses, of anti-Stokes pulses, and of the material excitation along the medium, while taking into account the pump pulse depletion. Said model may be a Raman amplifier, converter and/or generator model. Said model may be a model for pulses that may be short in comparison with the collisional de-excitation time of the medium. Said model may be referred to as a numerical single-pass transient model.

Thermally controlling may comprise providing phase matching or quasi-perfect phase matching between different waves of radiation in the system comprising an active medium.

Thermally controlling may comprise using Stimulated Anti-Stokes Raman Scattering, Stimulated Stokes Raman Scattering and Coherent Anti-Stokes Raman Scattering.

Thermally controlling may comprise selecting any or a combination of an active medium type, parameters of the active medium, and optical input parameters such that the scattering linewidth in the active medium is narrowed by a line narrowing effect and such that the pump can evoke a mechanism that adapts the material dispersion of the active medium. The line narrowing effect may be the Dicke line narrowing effect. The mechanism that adapts the material dispersion of the active medium may be electromagnetically induced transparency. With optical input parameters there may be meant pump parameters, Stokes input parameters and/or anti-Stokes input parameters. With pump parameters there may be meant any or a combination of e.g. a pump input power, a beam profile of a pump input beam, a pump wavelength, a pump polarisation, a pump phase, a pump propagation direction, a pump propagation sense, and a pump spectral linewidth.

Thermally controlling may comprise adapting any or a combination of parameters of the pump radiation, parameters of the Stokes radiation, parameters of the anti-Stokes radiation, differences in phase between a pump input, a Stokes input and/or an anti-Stokes input, differences in polarisation between a pump input, a Stokes input and/or an anti-Stokes input, ratios between a pump input power, a Stokes input power and/or an anti-Stokes input power, angles between a pump input beam, a Stokes input beam and/or an anti-Stokes input beam, parameters of the active medium, parameters of the cavity mirrors, a distance or distances between cavity mirrors, an angle or angles between the optical axes of cavity mirror sets, a compensating phase-matching or quasi-perfect-phase-matching part with or next to the active medium, and pulse parameters in case of pulsed operation. It is to be noted that parameters of the pump radiation may be any or a combination of e.g. a pump input power, a beam profile of a pump input beam, a pump wavelength, a pump polarisation, a pump phase, a pump propagation direction, a pump propagation sense and a pump spectral linewidth. It is to be noted that parameters of the Stokes radiation may be any or a combination of e.g. a Stokes input power, a Stokes wavelength, a beam profile of a Stokes input beam, a polarisation of the Stokes input beam, a phase of the Stokes input beam, a Stokes propagation direction, a Stokes propagation sense and a Stokes spectral linewidth. It is to be noted that parameters of the anti-Stokes radiation may be any or a combination of e.g. an anti-Stokes input power, an anti-Stokes wavelength, a beam profile of an anti-Stokes input beam, a polarisation of an anti-Stokes input beam, a phase of an anti-Stokes input beam, an anti-Stokes propagation direction, an anti-Stokes propagation sense and an anti-Stokes spectral linewidth. It is to be noted that parameters of the active medium may be any or a combination of e.g. a Raman gain of the active medium, a scattering linewidth of the active medium, optical losses of the active medium, a length of the active medium, an intrinsic phase mismatch of the medium, a structure of the active medium, features of a geometrical configuration of the medium, features of regions of different index of refraction in cross sections of the active medium perpendicular to the optical axis, and gas parameters of a gaseous component. The initial temperature of the active medium may also be a parameter of the active medium. It is to be noted that parameters of the cavity mirrors may be any or a combination of e.g. reflectivities of cavity mirrors, a phase shift of the cavity mirrors, a radius of curvature of the cavity mirrors and a polarisation effect of the cavity mirrors. It is to be noted that pulse parameters may be any or a combination of e.g. a length of input pulses, a temporal shape of input pulses, a spatial shape of input pulses, a repetition rate of input pulses.

The present invention also relates to a method for thermally controlling an active medium by radiative cooling based on stimulated Raman scattering processes and/or coherent Raman scattering processes.

The present invention also relates to a system comprising an active medium for generating radiation, the system being adapted for being thermally controlled by radiative cooling based on invoked, i.e. coherent and/or stimulated, Raman scattering processes. It is to be noted that invoked Raman scattering processes may be stimulated and/or coherent Raman scattering processes such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes.

The system may be defined by a number of system parameters and the efficiencies of Raman scattering processes may be tailored by selecting parameter values, preferably optimal parameter values, and/or parameter settings, preferably optimal parameter settings, for said system parameters. Parameter settings thereby may refer to non-numerical parameter selections such as e.g. Gaussian beam or Bessel beam for the beam profile.

The selected parameter values and/or parameter settings may be such that, in operation, the ratio of the number of anti-Stokes Raman scattered photons to the number of Stokes Raman scattered photons reaches a global or local maximum or substantially a value close to a global or local maximum. Close to a global or local maximum may be within 30%, preferably within 10%, more preferably within 5% of said absolute or local maximum.

The active medium may be an undoped Raman-active medium or a doped medium with a Raman-active host.

The system parameters may be any or a combination of parameters of the pump radiation, parameters of the Stokes radiation, parameters of the anti-Stokes radiation, differences in phase between the pump input, Stokes input and/or anti-Stokes input, differences in polarisation between the pump input, Stokes input and/or anti-Stokes input, ratios between a pump input power, a Stokes input power and/or an anti-Stokes input power, angles between a pump input beam, a Stokes input beam and/or an anti-Stokes input beam, parameters of the active medium, parameters of the cavity mirrors, a distance or distances between cavity mirrors, an angle or angles between the optical axes of cavity mirror sets, a compensating phase-matching or quasi-perfect-phase-matching part with or next to the active medium, and pulse parameters in case of pulsed operation. It is to be noted that parameters of the pump radiation may be, where applicable, any or a combination of e.g. a pump input power, a beam profile of a pump input beam, a pump wavelength, a pump polarisation, a pump phase, a pump propagation direction, a pump propagation sense, and a pump spectral linewidth. It is to be noted that parameters of the Stokes radiation may be, where applicable, any or a combination of e.g. a Stokes input power, a Stokes wavelength, a beam profile of a Stokes input beam, a polarisation of the Stokes input beam, a phase of the Stokes input beam, a Stokes propagation direction, a Stokes propagation sense, and a Stokes spectral linewidth. It is to be noted that parameters of the anti-Stokes radiation may be, where applicable, any or a combination of e.g. an anti-Stokes input power, an anti-Stokes wavelength, a beam profile of an anti-Stokes input beam, a polarisation of an anti-Stokes input beam, a phase of an anti-Stokes input beam, an anti-Stokes propagation direction, an anti-Stokes propagation sense, and an anti-Stokes spectral linewidth. It is to be noted that parameters of the active medium may be, where applicable, any or a combination of e.g. a Raman gain of the active medium, a scattering linewidth of the active medium, optical losses of the active medium, a length of the active medium, an intrinsic phase mismatch of the medium, a structure of the active medium, features of a geometrical configuration of the medium, features of regions of different index of refraction in cross sections of the active medium perpendicular to the optical axis, and gas parameters of a gaseous component. The initial temperature of the active medium may also be a parameter of the active medium. It is to be noted that parameters of the cavity mirrors may be, where applicable, any or a combination of e.g. reflectivities of cavity mirrors, a phase shift of the cavity mirrors, a radius of curvature of the cavity mirrors and a polarisation effect of the cavity mirrors. It is to be noted that pulse parameters may be, where applicable, any or a combination of e.g. a length of input pulses, a temporal shape of input pulses, a spatial shape of input pulses, a repetition rate of input pulses.

The system may comprise a phase matching part or a quasi-perfect-phase-matching part in the cavity.

The present invention also relates to a system for thermally controlling an active medium by radiative cooling based on stimulated Raman scattering processes and/or coherent Raman scattering processes.

The present invention furthermore relates to a controller for controlling a system comprising an active medium for generating radiation, the system comprising an active medium for generating radiation, the system being adapted for being thermally controlled by radiative cooling based on invoked, i.e. coherent and/or stimulated, Raman scattering processes. It is to be noted that invoked Raman scattering processes may be stimulated and/or coherent Raman scattering processes such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes. The present invention also relates to a controller for thermally controlling an active medium by radiative cooling based on stimulated Raman scattering processes and/or coherent Raman scattering processes.

The present invention also relates to a method for thermally controlling a system comprising an active medium for generating radiation, the method comprising providing generation of radiation and controlling the efficiencies of invoked, i.e. coherent and/or stimulated, Raman scattering processes during generation of radiation. It is to be noted that invoked Raman scattering processes may be stimulated and/or coherent Raman scattering processes such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes. Said controlling the efficiencies of invoked Raman scattering processes may comprise any of parameters of the pump radiation, parameters of the Stokes radiation, parameters of the anti-Stokes radiation, differences in phase between a pump input, a Stokes input and/or an anti-Stokes input, differences in polarisation between a pump input, a Stokes input and/or an anti-Stokes input, ratios between a pump input power, a Stokes input power and/or an anti-Stokes input power, angles between a pump input beam, a Stokes input beam and/or an anti-Stokes input beam, parameters of the active medium, parameters of the cavity mirrors, a distance or distances between cavity mirrors, an angle or angles between the optical axes of cavity mirror sets, and pulse parameters in case of pulsed operation. It is to be noted that parameters of the pump radiation may be, where applicable, any or a combination of e.g. a pump input power, a beam profile of a pump input beam, a pump wavelength, a pump polarisation, a pump phase, a pump propagation direction, a pump propagation sense and a pump spectral linewidth. It is to be noted that parameters of the Stokes radiation may be, where applicable, any or a combination of e.g. a Stokes input power, a Stokes wavelength, a beam profile of a Stokes input beam, a polarisation of the Stokes input beam, a phase of the Stokes input beam, a Stokes propagation direction, a Stokes propagation sense, and a Stokes spectral linewidth. It is to be noted that parameters of the anti-Stokes radiation may be, where applicable, any or a combination of e.g. an anti-Stokes input power, an anti-Stokes wavelength, a beam profile of an anti-Stokes input beam, a polarisation of an anti-Stokes input beam, a phase of an anti-Stokes input beam, an anti-Stokes propagation direction, an anti-Stokes propagation sense, and an anti-Stokes spectral linewidth. It is to be noted that parameters of the active medium may be, where applicable, any or a combination of e.g. a Raman gain of the active medium, optical losses of the active medium, a scattering linewidth of the active medium, a length of the active medium, an intrinsic phase mismatch of the medium, a structure of the active medium, features of a geometrical configuration of the medium, features of regions of different index of refraction in cross sections of the active medium perpendicular to the optical axis, and gas parameters of a gaseous component. The initial temperature of the active medium may also be a parameter of the active medium. It is to be noted that parameters of the cavity mirrors may be, where applicable, any or a combination of e.g. reflectivities of cavity mirrors, a phase shift of the cavity mirrors, a radius of curvature of the cavity mirrors and a polarisation effect of the cavity mirrors. It is to be noted that pulse parameters may be, where applicable, any or a combination of e.g. a length of input pulses, a temporal shape of input pulses, a spatial shape of input pulses, a repetition rate of input pulses.

The present invention also relates to a computer program product for executing a method for setting up a system comprising an active medium, the method comprising thermally controlling said system comprising an active medium by radiative cooling based on invoked, i.e. coherent and/or stimulated, Raman scattering processes, as described above. The method may comprise thermally controlling said active medium. It is to be noted that invoked Raman scattering processes may be stimulated and/or coherent Raman scattering processes such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes.

The present invention furthermore relates to a machine readable data storage device storing such a computer program product and to the transmission of such a computer program product over a local or wide area telecommunications network.

It is an advantage of embodiments of the present invention that these allow thermally controlling and/or cooling an active, lasing medium. It is an advantage of embodiments of the present invention that an alternative for thermally controlling an active medium is provided. It is also an advantage of embodiments of the present invention that methods and systems based on an alternative radiative cooling mechanism are provided that do not make use of spontaneous fluorescence signals, but of scattering phenomena taking place inside active media.

It is an advantage of embodiments of the present invention that these do not impose stringent requirements on the active media used for obtaining efficient thermal control. It is an advantage of particular embodiments of the present invention that they can be applied to e.g. gaseous, liquid, solid, semiconductor or fibre-based Raman-active media, but also to active media comprising a Raman-active host which is doped with ions. It is also an advantage of embodiments of the present invention that there are no stringent requirements on the specific absorption and emission/fluorescence spectra or Raman spectra of the active medium. Also, methods of the present invention may be performed independently from the Raman gain. Furthermore, it is an advantage of embodiments of the present invention that there is no requirement for low quantum defects, i.e. for small differences between the input and output photon energies. For example, in the case of Raman-active media, there is no requirement for low energy internal oscillations at which e.g. the pump photons are scattered.

It is an advantage of embodiments of the present invention that they can be applied to different types of active-medium-based systems, such as e.g. laser setups or oscillator setups comprising active media that are placed inside cavity mirrors, and amplifier setups, generator setups or converter setups where there are no cavity mirrors surrounding the media.

It is furthermore an advantage of embodiments of the present invention that there can be a certain degree of tunability of the applicable pump wavelengths and thus also of the Raman-scattered output wavelengths for the active-medium-based system, as long as the optical losses of the medium at the pump wavelength and at the Raman-scattered output wavelengths are sufficiently low for the Raman scattering processes to take place. The tunability range also may depend on the available pump wavelengths.

It is also an advantage of embodiments of the present invention that they can be easily combined with other cooling methods.

It is furthermore an advantage of embodiments of the present invention that they provide a non-contact method of thermal control, i.e. that no heat sink in contact with the active-medium-based system is required.

It is also an advantage of some embodiments of the present invention that the Raman-scattered output beam of the active-medium-based system can have a non-diffracting Bessel shape.

It is furthermore an advantage of embodiments of the present invention that a more homogenous temperature distribution is obtained in the active-medium-based system.

It is also an advantage of embodiments of the present invention that they can be applied to high power active-medium-based systems. Such high power active-medium-based systems may have, in case of pulsed operation, average output powers at least of the order of magnitude of 10 mW, more preferably at least of the order of magnitude of 100 mW, even more preferably at least of the order of magnitude of 1 kW, even more preferably at least of the order of magnitude of 2 kW, or such high power active-medium-based systems may have, in case of pulsed operation, output pulse energies at least of the order of magnitude of 10 mJ, more preferably at least of the order of magnitude of 100 mJ, even more preferably at least of the order of magnitude of 1 J, even more preferably at least of the order of magnitude of 2 J. The present invention can also be applied to high power continuous-wave active-medium-based systems that may have output powers at least of the order of magnitude of 1 WI more preferably at least of the order of magnitude of 10 W, even more preferably at least of the order of magnitude of 1 kW, even more preferably at least of the order of magnitude of 10 kW.

It is furthermore an advantage of embodiments of the present invention that the unwanted heat generation in the active-medium-based systems may be reduced with a percentage more than 10%, more preferably with a percentage between 10% and 100%, even more preferably with a percentage between 30% and 100%, even more preferably with a percentage between 60% and 100%, or even that the embodiments of the present invention may cause the active-medium-based systems to cool down instead of heating up.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The teachings of the present invention permit the design of improved methods and apparatus for thermal control of active-medium-based systems and active-medium-based systems which are thermally controlled in this way. The above and other characteristics, features and advantages of the present invention wilt become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

How the present invention may be put into effect will now be described by way of example with reference to the appended drawings, in which:

FIG. 1—prior art shows fluorescence and absorption spectra for a radiative cooling method based on spontaneous anti-Stokes shifted fluorescence as known from prior art.

FIG. 2 shows an energy diagram for Stimulated Stokes Raman Scattering as can be used in embodiments according to the present invention.

FIG. 3 shows an energy diagram for Stimulated Anti-Stokes Raman Scattering as can be used in embodiments according to the present invention.

FIG. 4a shows an energy diagram for Coherent Anti-Stokes Raman Scattering as can be used in embodiments according to the present invention.

FIG. 4b shows, from another point of view than in FIG. 4a, the energy and phonon annihilation diagram for Coherent Anti-Stokes Raman Scattering in case of perfect phase matching, as can be used in embodiments according to the present invention.

FIG. 5 shows a laser setup or oscillator setup that may be thermally controlled by the use of methods according to the first and second embodiments of the present invention.

FIG. 6 shows a setup for an amplifier, a generator or a converter that may be thermally controlled by the use of methods according to the first and second embodiments of the present invention.

FIG. 7 shows a computing system for an active-medium-based system that may be thermally controlled according to the methods as described in the first and second embodiments of the present invention.

FIG. 8 shows a schematic representation of the iterative resonator model, as can be used in a method for setting up active-medium-based systems according to the first aspect of the present invention.

FIG. 9 and FIG. 10 show the evolution, according to the iterative resonator model, of the number of output photons per unit time through the front and back mirrors for an active-medium-based system, i.e. a hydrogen-based system, with a phase mismatch of 3.84 rad/cm as can be obtained using a method for setting up an active-medium-based system according to the first aspect of the present invention.

FIG. 11, FIG. 12 and FIG. 13 show the variations, according to the iterative resonator model, of the number of Stokes output photons per unit time, of the number of anti-Stokes output photons per unit time, and of the ratio of the number of extracted anti-Stokes photons to the number of extracted Stokes photons through the cavity mirrors per unit time, respectively, for an active-medium-based system, i.e. a hydrogen-based system, with a phase mismatch of 3.84 rad/cm and for an anti-Stokes mirror reflectivity increasing from 0.8898 to 0.9998 in steps of 0.01 as can be obtained using a method for setting up active-medium-based systems according to the first aspect of the present invention.

FIG. 14 shows the evolution, according to the iterative resonator model, of the number of output photons per unit time through the front and back mirrors, for an active-medium-based system, i.e. a hydrogen-based system, with a perfect phase match, as can be obtained using a method according to the first aspect of the present invention.

FIG. 15, FIG. 16 and FIG. 17 show the variations, according to the iterative resonator model, of the number of Stokes output photons per unit time, of the number of anti-Stokes output photons per unit time, and of the ratio of the number of extracted anti-Stokes photons to the number of extracted Stokes photons through the cavity mirrors per unit time, respectively, for an active-medium-based system, i.e. a hydrogen-based system, with a perfect phase match and for an anti-Stokes mirror reflectivity increasing from 0.20 to 0.23 in steps of 0.01 as can be obtained using a method for setting up active-medium-based systems according to the first aspect of the present invention.

FIG. 18a and FIG. 18b show the evolution, according to the iterative resonator model, of the number of output photons per unit time through the front and back mirrors for an active-medium-based system, i.e. a hydrogen-based system, with a perfect phase match and with a pump source featuring a spectral linewidth of 2 GHz as can be obtained using a method for setting up an active-medium-based system according to the first aspect of the present invention.

FIG. 19 shows the evolution, according to the iterative resonator model, of the number of output photons per unit time through the front and back mirrors for an active-medium-based system, i.e. a silicon-based system, with a perfect phase match and with a pump source featuring a spectral linewidth of 300 GHz as can be obtained using a method for setting up an active-medium-based system according to the first aspect of the present invention.

FIG. 20 shows a schematic representation of the numerical single-pass transient model, as can be used in a method for setting up active-medium-based systems according to the first aspect of the present invention.

FIG. 21 shows for an active-medium-based system, i.e. a hydrogen-based system, with a phase mismatch of 500 mrad/cm, the evolution, according to the numerical single-pass transient model, of the ratio of the number of extracted anti-Stokes photons to the number of extracted Stokes photons per unit time along the medium as can be obtained using a method for setting up active-medium-based systems according to the first aspect of the present invention.

FIG. 22 shows for an active-medium-based system, i.e. a hydrogen-based system, with a phase mismatch of 500 mrad/cm, the evolution, according to the numerical single-pass transient model, of the ratio of the accumulated number of extracted anti-Stokes photons to the accumulated number of extracted Stokes photons per unit time along the medium as can be obtained using a method for setting up active-medium-based systems according to the first aspect of the present invention.

FIG. 23 shows for an active-medium-based system, i.e. a hydrogen-based system, with a phase mismatch of 40 mrad/cm, the evolution, according to the numerical single-pass transient model, of the ratio of the number of extracted anti-Stokes photons to the number of extracted Stokes photons per unit time along the medium as can be obtained using a method for setting up active-medium based systems according to the first aspect of the present invention.

FIG. 24 shows for an active-medium-based system, i.e. a hydrogen-based system, with a phase mismatch of 40 mrad/cm, the evolution, according to the numerical single-pass transient model, of the ratio of the accumulated number of extracted anti-Stokes photons to the accumulated number of extracted Stokes photons per unit time along the medium as can be obtained using a method for setting up active-medium based systems according to the first aspect of the present invention.

FIG. 25 shows for an active-medium-based system, i.e. a silicon-based system, with a phase mismatch of 400 mrad/cm, the evolution, according to the numerical single-pass transient model, of the ratio of the number of extracted anti-Stokes photons to the number of extracted Stokes photons per unit time along the medium with the photons extracted due to propagation losses included, as can be obtained using a method for setting up active-medium based systems according to the first aspect of the present invention.

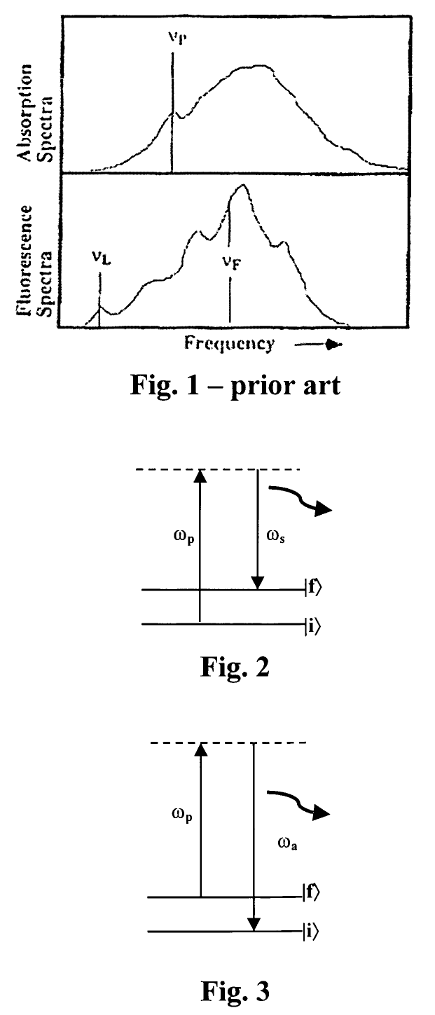

### DESCRIPTION OF THE PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The invention will now be described by a detailed description of several embodiments of the invention. It is clear that other embodiments of the invention can be configured according to the knowledge of persons skilled in the art, the invention being limited only by the terms of the appended claims.

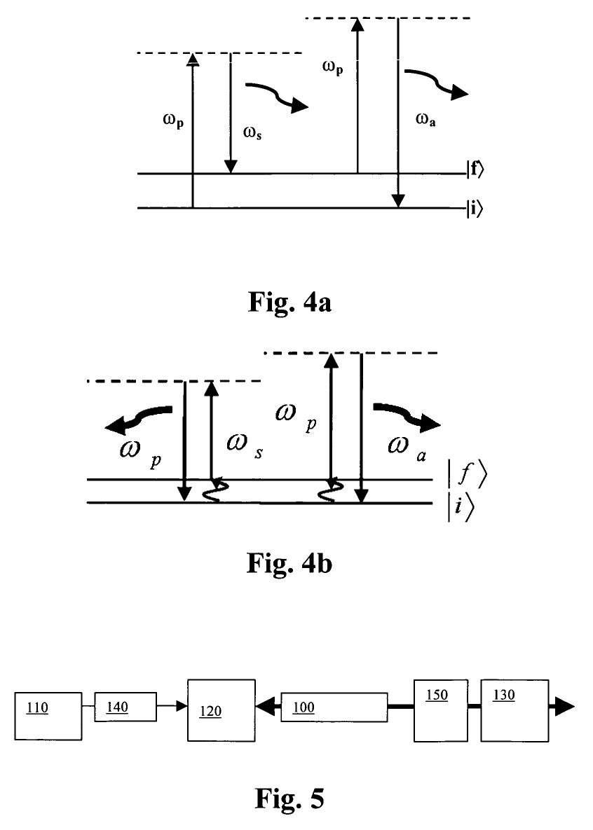

The embodiments of the present invention relate to cooling, or more accurately, thermally controlling an active medium or an active medium comprised in a system, also referred to as thermally controlling an active-medium-based system. It may relate to systems for thermally controlling an active medium, to systems with a thermally controlled active medium, to methods for thermally controlling an active-medium-based system and to methods for designing thermally controlled active-medium-based systems. The active medium thereby may be e.g. a Raman-active medium. Thermally controlling may be e.g. reducing or preventing heat generation in the active medium, but also may be cooling of the active medium. In the present invention thermally controlling an active medium is based on reducing or eliminating phonon generation, or on establishing annihilation of phonons through conversion of incident pump photons to anti-Stokes Raman scattered photons. Raman scattering essentially means the conversion of pump photons into lower energy photons, also referred to as Stokes photons, or into higher energy photons, also referred to as anti-Stokes photons, through a scattering interaction with a Raman-active medium. The energy difference between the incident pump photons and the scattered output photons corresponds to the frequency of an internal oscillation of the medium, such as e.g. a molecular vibration or, as is e.g. the case for quantum cascade Raman lasers, an oscillation caused by electrons inside the medium. Embodiments of the present invention typically are based on invoked Raman scattering processes. These are stimulated and/or coherent Raman scattering processes, such as e.g. Stimulated Stokes Raman Scattering, Stimulated Anti-Stokes Raman Scattering and Coherent Anti-Stokes Raman Scattering. It is to be noted that fluorescence and spontaneous Raman scattering processes do not fall within the scope of invoked Raman scattering processes. Different invoked Raman scattering processes will first be discussed in more detail, with reference to FIG. 2, FIG. 3 and FIGS. 4a and 4b. In FIG. 2, FIG. 3 and FIGS. 4a and 4b, three different invoked Raman scattering processes are illustrated, being Stimulated Stokes Raman Scattering, Stimulated Anti-Stokes Raman Scattering and Coherent Anti-Stokes Raman Scattering, respectively. The horizontal solid lines in FIG. 2, FIG. 3 and FIGS. 4a and 4b correspond to existing energy levels of the medium, while the horizontal dashed lines correspond to intermediate states of the scattering processes which may be strongly or weakly detuned from existing energy levels of the medium. In these figures, the subscription ‘p’ represents an incident pump photon, the subscription ‘s’ represents a generated Stokes-scattered photon and the subscription ‘a’ represents a generated anti-Stokes-scattered photon. The energy difference between the energy levels ‘i’ and ‘f’ corresponds with an internal oscillation in the medium, such as e.g. a molecular vibration, and this internal oscillation causes the incident pump photon or photons ‘p’ to scatter. The energy levels may be e.g. discrete energy levels or energy bands. With Stimulated Stokes Raman Scattering illustrated in FIG. 2, only Stokes-scattered photons with an energy lower than the pump photon energy are generated, and the generation of a Stokes photon is accompanied by the creation of a quantum of oscillation energy in the medium or a phonon, resulting in heat generation inside the medium. With Stimulated Anti-Stokes Raman Scattering illustrated in FIG. 3, only anti-Stokes-scattered photons with an energy higher than the pump photon energy are generated, and as a consequence, no phonon creation but phonon annihilation takes place here, resulting in heat extraction from the medium. With Coherent Anti-Stokes Raman Scattering, which is a four-wave mixing process illustrated in FIG. 4a, both Stokes-scattered and anti-Stokes-scattered photons are created, meaning that neither phonon creation nor phonon annihilation takes place, and that no heat is exchanged with the medium. From another point of view, Coherent Anti-Stokes Raman Scattering is a Raman-resonant four-wave mixing process that—in case of perfect phase matching—converts a pump photon and a Stokes photon into a pump photon and an anti-Stokes photon, while annihilating two phonons. This process is visualized in FIG. 4b. In case of a phase mismatch, the induced phase variation along the fields' propagation path will cause the process shown in FIG. 4b to alternate with the reverse mechanism, where all transitions in the four-wave mixing scheme will take place in the opposite directions. The reasoning above is valid for Stimulated Stokes Raman Scattering, Stimulated Anti-Stokes Raman Scattering and Coherent Anti-Stokes Raman Scattering of first order and of higher orders.

Among the three previously mentioned Raman scattering processes, Coherent Anti-Stokes Raman Scattering is quite different from the other two scattering mechanisms in that it is a four wave mixing process where the pump angular frequency ωₚ, the Stokes angular frequency ωₛ and the anti-Stokes angular frequency ωₐ need to meet the energy conservation law expressed by

2ωₚ−ωₛ−ωₐ=0 [1]

and where preferably phase matching or quasi-perfect phase matching is established in order to obtain a high efficiency for anti-Stokes generation. Phase matching or quasi-perfect phase matching requires that the condition for the pump wave vector k̅ₚ, for the Stokes wave vector k̅ₛ and for the anti-Stokes wave vector k̅ₐ expressed by

2 k̅ₚ− k̅ₛ− k̅ₐ= 0̅ or 2 k̅ₚ− k̅ₛ− k̅ₐ≈ 0̅ [2]

respectively, is fulfilled.

In the present invention thermally controlling thus may be obtained substantially by tailoring the efficiencies of Raman scattering processes, such as e.g. the Raman scattering processes mentioned above, and to a less extent by tailoring the efficiencies of additional processes, such as e.g. self-phase modulation, cross-phase modulation and self-focusing, so that almost as many anti-Stokes photons as Stokes photons, as many anti-Stokes photons as Stokes photons, or even more anti-Stokes photons than Stokes photons are extracted from the active medium or active-medium-based system. In this way, the scattering processes may cause only a small amount of phonon creation and thus only a small amount of heat generation inside the active medium, no net phonon creation and thus no heating at all inside the active medium, or even phonon annihilation and thus heat extraction from the active medium, respectively. In other words, by tailoring the efficiencies of Raman scattering processes, e.g. the previously mentioned Raman scattering processes, in such a way that the ratio of the number of extracted anti-Stokes photons to the number of extracted Stokes photons reaches a maximum or reaches a value that is close to a maximum, heat generation in the active medium may be controlled. Almost the maximal ratio of the number of extracted anti-Stokes photons to the number of extracted Stokes photons may be preferred over the maximal ratio in case the maximal ratio corresponds with a low total number of photons generated in these scattering processes. In other words, choosing a working point where the photon number ratio reaches a value close to a maximum instead of the maximum, might be useful e.g. in case the absolute photon numbers at the working point corresponding with the maximum photon number ratio are relatively low, e.g. substantially lower than for a photon number ratio that is almost maximal. It is to be noted that the extracted photons one refers to, comprise the photons that are coupled out at all boundaries of the active medium or active-medium-based system and comprise also the photons that are lost in the active medium or active-medium-based system due to e.g. medium-dependent losses.

Embodiments of the present invention for solving thermal problems of an active-medium-based system thus are based on using radiation for thermally controlling an active medium, and thus can be referred to as belonging to the category of radiative cooling mechanisms. They open up new ways to increase the useful power output, and/or to make more compact active-medium-based systems.

The embodiments using the above described thermal control have the advantage that there are no major restrictions on the active medium used. In other words, the invention may be applicable to a wide variety of active media and systems comprising these media. For thermally controlling systems using thermal control as described above, the active media may be e.g. gaseous, liquid, solid, semiconductor, or fibre-based Raman-active media such as e.g. hydrogen gas, Rhodamine 6G laser dye, Ba(NO₃)₂, silicon, and silica fibre, respectively, but it may also be active media comprising a Raman-active host which is doped with ions, such as e.g. Nd³⁺:KGd(WO₄)₂. No stringent requirements are present on the specific absorption and emission/fluorescence spectra or Raman spectra of the active medium. Also, methods of the present invention may be performed independently from the Raman gain. A further advantage is that there is no requirement for low quantum defects, i.e. for small differences between the input and output photon energies. E.g. in the case of Raman-active media, there is no requirement for low energy internal oscillations at which e.g. the pump photons are scattered. Also, the methods of thermal control can be applied to different types of active-medium-based systems, such as e.g. laser setups or oscillator setups comprising active media that are placed inside cavity mirrors, and amplifier setups, generator setups or converter setups where there are no cavity mirrors surrounding the media. Special examples of such active-medium-based systems are Raman lasers, which are laser setups comprising Raman-active media that are responsible for the generation of a frequency shifted laser output through Raman scattering interactions with the incoming pump radiation. The possibility of applying this cooling concept to e.g. the recently developed silicon-based Raman lasers and quantum cascade Raman lasers, opens up many application possibilities in the fields of opto-electronics and semiconductor photonics. Moreover, the thermally controlling methods may be efficiently used in a high power active-medium-based system. E.g. the methods of thermal control may be applied to high power pulsed active-medium-based systems that may have average output powers at least of the order of magnitude of 10 mW, more preferably at least of the order of magnitude of 100 mW, even more preferably at least of the order of magnitude of 1 kW, even more preferably at least of the order of magnitude of 2 kW or to high power pulsed active-medium-based systems that may have output pulse energies at least of the order of magnitude of 10 mJ, more preferably at least of the order of magnitude of 100 mJ, even more preferably at least of the order of magnitude of 1 J, even more preferably at least of the order of magnitude of 2 J. The methods of thermal control may also be applied to high power continuous-wave active-medium-based systems that may have output powers at least of the order of magnitude of 1 W, more preferably at least of the order of magnitude of 10 W, even more preferably at least of the order of magnitude of 1 kW, even more preferably at least of the order of magnitude of 10 kW. Furthermore, the thermally controlling methods may reduce the unwanted heat generation in active-medium-based systems with a percentage more than 10%, more preferably with a percentage between 10% and 100%, even more preferably with a percentage between 30% and 100%, even more preferably with a percentage between 60% and 100%, and the thermally controlling methods may even cause the active-medium-based systems to cool down instead of heating up. Moreover, there may be a certain degree of tunability of the Raman scattered output of the active-medium-based system, i.e. the pump wavelength and thus also the Stokes and anti-Stokes output wavelengths can be tuned over a tuning range that may be larger than for prior art systems. For a hydrogen-based Raman laser, for example, one can use e.g. a frequency-doubled Nd:YAG laser emitting at 532 nm as pump laser, and then, the resulting Stokes and anti-Stokes wavelengths are in case of a Raman shift of 4155 cm⁻¹ equal to 683 nm and 436 nm, respectively. Another possible pump source is a tunable BeAl₂O₄:Cr³⁺ laser or alexandrite laser, which, in case it is tuned to 742 nm for example, will cause the medium to generate Stokes and anti-Stokes radiation at a wavelength of 1074 nm and 567 nm, respectively. Also for other media than hydrogen, there is a wide range for possible pumping frequencies, since Raman scattering can also be established when the intermediate states are strongly detuned from the existing energy levels of the medium under consideration. In principle, the tunability for the pump wavelength and for the Raman scattered output wavelengths preferably is such that the optical losses of the medium at the pump wavelength and at the Raman-scattered output wavelengths are sufficiently low for the Raman scattering processes to take place. The methods and systems using thermal control as described above may result in conical shaped output beams in case a non-collinear phase matching is established for the Coherent Anti-Stokes Raman Scattering process. These conical shaped output beams may be non-diffracting Bessel beams, which are an attractive alternative to e.g. Gaussian profiled beams due to e.g. their long region of focus along the optical axis. This line focus has important applications in e.g. optical alignment, non-linear optics, microlithography, target ranging, Doppler velocity estimation, medical imaging, and tissue characterization. It is an additional advantage of embodiments of the present invention that the thermal control as described above can be easily combined with other cooling methods. It is also an advantage of embodiments of the present invention that they provide a non-contact thermal control, i.e. that no heat sink in contact with the active-medium-based system is required. It is furthermore an advantage of embodiments of the present invention that they provide a more homogenous temperature distribution in the active-medium-based system.

Different features of embodiments and aspects of the present invention will be further described in more detail by way of exemplary embodiments.

In a first aspect, the present invention relates to a method for setting up a thermally controlled active-medium-based system whereby the thermal control is based on radiative cooling using Raman scattering processes, as described above. Setting up a thermally controlled system may comprise tailoring the system configuration such that the efficiencies of the Raman scattering processes occurring therein are tailored as described above. The setting up methods for setting up thermally controlled systems may use optimisation of ‘external’ parameters, i.e. system parameters that are not directly related to the medium, which will be discussed in the first embodiment of the first aspect of the present invention. Methods for setting up thermally controlled systems by optimisation of ‘internal’ parameters, which are the parameters directly related to the medium, will be addressed in the second embodiment of the first aspect of the present invention. Furthermore, tailoring the efficiencies of Raman scattering processes may also be performed by combining optimisation of external parameters and internal parameters.

In a first embodiment of the first aspect, the invention thus relates to methods for setting up thermally controlled active-medium-based systems, thermally controlled by the use of radiative cooling based on Raman scattering processes. In other words, the thermal status of the active-medium-based system is controlled by reducing or preventing heating of the active medium or by extracting heat from the medium, which loses the corresponding energy by generating, e.g. emitting radiation. The radiative cooling mechanism is based on optimising the extraction of anti-Stokes Raman scattered photons as a function of the extraction of Stokes Raman scattered photons. In the present embodiment, this optimisation is performed by adapting ‘external’ parameters of an active-medium-based system, i.e. the parameters of the system that are not directly related to the medium e.g. parameters related to the system and the environment of the active medium.

The method for setting up thermally controlled active-medium-based systems may comprise the step of tailoring the efficiencies of Raman scattering processes. Tailoring the efficiencies of the previously mentioned Raman scattering processes may be performed by optimising external parameters of an active-medium-based system. Such external parameters may be for example the incident pump power, the pump beam profile, the pump polarisation, the pump phase, the pump wavelength, the pump propagation direction, the pump propagation sense, the pump spectral linewidth and if relevant for the active-medium-based system under consideration, the reflectivities of the cavity mirrors, the phase shift of the cavity mirrors, the radius of curvature of the cavity mirrors, the polarisation effect of the cavity mirrors, the distance or distances between the cavity mirrors, the angle or angles between the optical axes of the mirror sets, the power and beam profile of the Stokes input beam, the polarisation and the phase of the Stokes input beam, the Stokes propagation direction and sense, the Stokes spectral linewidth, the power and beam profile of the anti-Stokes input beam, the polarisation and the phase of the anti-Stokes input beam, the anti-Stokes propagation direction and sense, the anti-Stokes spectral linewidth, the ratios between the pump, Stokes and/or anti-Stokes input powers, the angles between the pump, Stokes and/or anti-Stokes input beam, the differences between the pump, Stokes and/or anti-Stokes phase, the differences between the pump, Stokes and/or anti-Stokes polarisation, the length of the input pulses, the temporal and spatial shape of the input pulses and the repetition rate of the input pulses, etc. By selecting the pump beam profile, e.g. other phase matching conditions may be obtained resulting in different efficiencies of the Raman scattering processes. One will obtain e.g. other phase matching conditions for a Bessel pump beam than for a Gaussian pump beam. The polarisation of the pump beam, the orientation of the polarisation with respect to e.g. the crystal axes of a crystalline active medium, the propagation direction of the pump beam with respect to e.g. the crystal axes of a crystalline active medium, and the propagation sense of the pump beam may influence the scattering efficiencies, and thus may be used for tailoring the efficiencies of the Raman scattering processes. Regarding the pump wavelength, one will obtain e.g. different scattering efficiencies when the pump wavelength is tuned far away or closely to existing energy levels in the medium. Also the pump spectral linewidth influences the scattering efficiencies and can have a different influence for the scattering efficiencies in the co-propagating scattering direction than for those in the counter-propagating scattering direction. The as such obtained different scattering efficiencies again allow to tailor the efficiencies of the Raman scattering processes. For an amplifier, generator or converter setup, the efficiencies of the previously mentioned Raman scattering processes can also be tailored by adaptation of the Stokes input beam profile and/or the anti-Stokes input beam profile, and/or also by optimisation of the Stokes input power, the anti-Stokes input power, and/or the ratios between the pump input power, Stokes input power and/or anti-Stokes input power. One can also modify the propagation direction and sense of the Stokes and anti-Stokes input beams, the spectral linewidth of the Stokes and anti-Stokes input beams, the polarisation of the Stokes and anti-Stokes input beams, the phase of the Stokes and anti-Stokes input beams, and the differences in polarisation and phase between the pump input beam, the Stokes input beam and the anti-Stokes input beams. This again allows to tailor the efficiencies of the Raman scattering processes. In addition, one can also optimise the angles between the pump input beam, the Stokes input beam and/or the anti-Stokes input beam in case of an amplifier, generator or converter setup. These angles play an important role for the phase matching conditions, again resulting in the possibility to tailor the efficiencies of the Raman scattering processes. For a laser setup or oscillator setup, also the reflectivities of the cavity mirrors at the relevant wavelengths, the phase shift of the cavity mirrors, the radius of curvature of the cavity mirrors, the polarisation effect of the cavity mirrors, and the distance between the cavity mirrors can be modified for tailoring the scattering processes. This distance is important with respect to phase jumps of the electric fields at the cavity mirrors, and thus also with respect to cavity resonances. In case more than one set of cavity mirrors is used for obtaining the selected reflectivity values at the pump, Stokes and anti-Stokes wavelengths, the distance between the cavity mirrors of each mirror set can be modified, and also the angle or angles between the optical axes of each mirror set can be optimised. E.g. in case three mirror sets are used for the pump, Stokes and anti-Stokes wavelengths, respectively, one can adapt the distance between the cavity mirrors for each of the three mirror sets separately, and one can optimise the angles between the optical axes of the three mirror sets. These angles play an important role for the phase matching conditions, which results in the possibility to tailor the efficiencies of the Raman scattering processes. In case of pulsed operation, one can also optimise the length, the temporal and spatial shape and the repetition rate of the input pulses. The optimisation of these pulse characteristics depends on e.g. the relaxation time of the medium under consideration, and allows to tailor the efficiencies of the Raman scattering processes.

Optimisation of these external parameters may be performed in several ways. Optimisation may be performed using theoretical models for the operation, calculations, specific computer implemented algorithms, neural networks or experimental testing.

Two examples of theoretical models that may be used are the so-called iterative resonator model and the so-called numerical single-pass transient model. The iterative resonator model, on one hand, is a continuous-wave or quasi-continuous-wave Raman laser model that describes half roundtrip per half roundtrip—this term refers to the propagation distance from the beginning to the end of the cavity or vice versa—the longitudinal variation of the forward- and backward-propagating pump, Stokes and anti-Stokes electromagnetic waves inside the cavity, and that calculates half roundtrip per half roundtrip what fraction of the forward- and backward-propagating pump, Stokes and anti-Stokes electromagnetic waves is coupled out of the cavity. Another model that may be used for modelling continuous-wave or quasi-continuous-wave Raman lasers is the rate equation model, but in general the iterative resonator model exhibits a better accuracy than the rate equation model, as will be explained in the first example of the present invention. The numerical single-pass transient model, on the other hand, is a Raman amplifier, converter and generator model for pulses that may be short in comparison with the collisional de-excitation time of the medium. This model allows accurately calculating the growth or decrease of Stokes pulses, of anti-Stokes pulses, and of the material excitation along the medium, while taking into account the pump pulse depletion. Another model that may be used for modelling such pulsed Raman amplifiers, converters and generators is based on analytic formulas, but this model is not as accurate as the numerical single-pass transient model since it does not incorporate the depletion of the pump pulses. The iterative resonator model and the numerical single-pass transient model will be explained more into detail in the examples of the present invention.

All of the optimisation methods described above are based on optimising the ratio of the number of extracted anti-Stokes photons to the number of extracted Stokes photons, e.g. on obtaining the highest ratio or almost the highest ratio of the number of extracted anti-Stokes photons to the number of extracted Stokes photons. Almost the highest ratio of the number of extracted anti-Stokes photons to the number of extracted Stokes photons may be preferred over the highest ratio in case the highest ratio corresponds with a low total number of photons generated in these scattering processes. In other words, choosing a working point where the photon number ratio reaches a value close to a maximum instead of the maximum, might be useful e.g. in case the absolute photon numbers at the working point corresponding with the maximum photon number ratio are relatively low, e.g. substantially lower than for a photon number ratio that is almost maximal. The optimisation methods may be such that optimisation is performed until a predetermined ratio of the number of extracted anti-Stokes photons to the number of extracted Stokes photons is obtained. It also may be such that a scan of the complete or partial parameter range of the external parameter under consideration is performed, whereby the parameter value/values or setting/settings resulting in the highest ratio or almost the highest ratio of the number of extracted anti-Stokes photons to the number of extracted Stokes photons is selected. Parameter settings thereby may refer to non-numerical parameter selections such as e.g. Gaussian beam or Bessel beam for the beam profile. Selection of parameter values or parameter settings may be done either systematic or at random.

In other words, the value or setting of an external parameter is selected by searching a maximum or a value close to a maximum for the ratio of the number of extracted anti-Stokes photons to the number of extracted Stokes photons. This maximum may be a local maximum or it may be a global maximum. Besides optimisation of a single external parameter, the same procedure may be applied to optimisation of a number of external parameters or a number of external and internal parameters. Plural parameters may be optimised in one procedure, whereby the parameter space spanned by the different parameter ranges is studied. This first embodiment according to the first aspect will be further illustrated by way of two examples. By optimising one or more parameters of the active-medium-based system, a design or setup for an active-medium-based system is obtained. The method according to the present invention may be performed in an automated way, e.g. based on specific computer implemented algorithms, neural networks, etc.

In a second embodiment according to the first aspect, the invention relates to methods for setting up thermally controlled active-medium-based systems, by the use of radiative cooling. In other words, the thermal status of the active medium-based-system is controlled by reducing or preventing heating of the active medium or by extracting heat from the medium, which loses the corresponding energy by generating, e.g. emitting radiation. The radiative cooling mechanism is based on optimising the extraction of anti-Stokes Raman scattered photons as a function of the extraction of Stokes Raman scattered photons. In the present embodiment, this optimisation is performed by adapting ‘internal’ parameters of an active-medium-based system, i.e. the parameters of the system that are directly related to the medium. The method for setting up thermally controlled active-medium-based systems may comprise the step of tailoring the efficiencies of Raman scattering processes. Tailoring the efficiencies of the previously mentioned Raman scattering processes can be performed by optimising internal parameters of the active-medium based system. These internal parameters may comprise e.g. the Raman gain of the medium, the scattering linewidth of the medium, the optical losses of the medium, the length of the medium, the medium structure, the intrinsic phase mismatch of the medium, etc. or it may also comprise adding a compensating phase-matching or quasi-perfect-phase-matching part with or next to the active medium. Another internal parameter which may be optimised, may be the initial temperature of the medium. For different media with different Raman gains and different scattering linewidths, different scattering efficiencies are obtained, and thus, selecting a Raman gain and scattering linewidth allows to tailor the Raman scattering efficiencies. Also by modifying the optical losses inside the medium, one can tailor the Raman scattering efficiencies. One can for example adapt the optical losses of e.g. a semiconductor Raman medium, such as a silicon-on-insulator waveguide for example, by applying a voltage across the waveguide. Optimising the medium structure may e.g. be performed by amending the composition of the medium. The latter refers to e.g. composing a layered medium from thin layers of Raman-active and Raman-passive materials to adapt the phase mismatch of the pump, Stokes and anti-Stokes waves throughout the structured medium. The latter allows to change the efficiencies of the Raman scattering processes. To obtain the same goal, one can also, in case of a laser setup or oscillator setup, add a compensating phase-matching or quasi-perfect-phase-matching part in the cavity with or next to the active medium. Another way to tailor the different Raman scattering processes is by changing the intrinsic phase mismatch of the medium. In case the Raman scattering processes take place in a birefringent material, e.g. silicon, that is comprised in a type of geometrical configuration, such as a waveguide structure for example, one can adapt the intrinsic phase mismatch not only by optimising e.g. the pump, Stokes and anti-Stokes wavelengths and powers, but also by optimising the features of the geometrical configuration, such as the dimensions for example. This optimisation should be carried out in such a way that the different contributions to the phase mismatch, such as e.g. the contributions of the configuration's birefringence and dispersion and the contribution of the material dispersion, result in a total phase mismatch for which the ratio of the number of extracted anti-Stokes photons to the number of extracted Stokes photons reaches a maximum or a value close to a maximum. Similarly, one can change the intrinsic phase mismatch of a medium of which the cross sections perpendicular to the optical axis contain regions of different index of refraction—this may be e.g. a photonic crystal or a microstructured optical fibre of which the air fraction contains a Raman-active medium such as Rhodamine 6G laser dye or hydrogen gas for example—by adapting e.g. the pump, Stokes and anti-Stokes wavelengths and powers, by optimising the features of the regions with different index of refraction in the cross section of the medium such as e.g. the size, periodicity and pattern of the regions with different index of refraction, and also by tuning the gas pressure in case the medium contains an air fraction that is filled with a gaseous Raman-active material. Still another way to tailor the intrinsic phase mismatch of the medium is by evoking a mechanism that adapts the material dispersion of the medium, such as e.g. electromagnetically induced transparency for example, a physical phenomenon which causes the pump, Stokes and anti-Stokes waves inside the material to propagate at almost the same velocity or at exactly the same velocity. The former case results in quasi-perfect phase matching, while the latter case leads to perfect phase matching.

One method to obtain electromagnetically induced transparency in Raman-active gases such as hydrogen gas for example, will be discussed in more detail. Regarding this topic, it is important to be aware of three preferred conditions for obtaining electromagnetically induced transparency in a Raman-active medium or in a medium comprising a Raman-active host. Firstly, electromagnetically induced transparency can only take place in case of high pump powers. Secondly, one has to make sure that the Raman scattering transitions are such that there is a large detuning of the intermediate states from the existing energy levels inside the medium. Thirdly, the medium should exhibit very narrow scattering linewidths for electromagnetically induced transparency to take place. The high pump power and the large detuning can be established by choosing the proper pump source with the proper power capabilities and emission wavelength. For having small scattering linewidths, one can choose a medium with narrow linewidths, such as solid hydrogen for example. However, one can also narrow down the Doppler-broadened linewidths of gas phase systems, such as Raman-active hydrogen gas for example, for the purpose of electromagnetically induced transparency. This can be achieved by the following method: first, one fills a gas container—this may be e.g. a classical Raman cell, but also a microstructured optical fibre such as a hollow-core photonic crystal fibre for example—with a Raman-active gas, e.g. hydrogen gas. After that, one regulates the gas parameters, such as the gas pressure for example, until the scattering linewidths narrow down due to a line narrowing mechanism. This mechanism can be e.g. the Dicke line narrowing effect, which takes place when the Doppler broadening, originating from the molecular translational energy of the gas, is counteracted by the collisions that the gas molecules experience. This Dicke line narrowing effect may cause scattering linewidths to become e.g. more than 15 times smaller. For example, a Doppler broadened scattering linewidth of the order of magnitude of 0.1 cm⁻¹ can be narrowed down to a scattering linewidth of the order of magnitude of 0.005 cm⁻¹. In this way, electromagnetically induced transparency can be evoked in Raman gases that intrinsically do not have narrow scattering linewidths. This method thus broadens the category of media in which electromagnetically induced transparency can be established and consequently also broadens the class of media that are suitable for obtaining quasi-perfect phase matching or even perfect phase matching. In the method for setting up, the step of filling the gas container and regulating the gas parameters typically are replaced by selecting a gas container and a gas to be used and selecting gas parameters that result in scattering linewidths narrowed down, e.g. due to a line narrowing mechanism such as e.g. the Dicke line narrowing effect. Narrowing the scattering linewidth by the use of a line narrowing mechanism for the purpose of electromagnetically induced transparency may also be applied for an active medium that is e.g. solid, whereby mutates mutandis providing and/or selecting a gas is replaced by providing and/or selecting e.g. a solid medium.

Optimisation of these internal parameters may be performed in several ways. Optimisation may be performed using theoretical models for the operation, calculations, specific computer implemented algorithms, neural networks or experimental testing.

Two examples of theoretical models that may be used, being the so-called iterative resonator model and the so-called numerical single-pass transient model, already have been briefly described in the first embodiment of the first aspect, and they will be explained more into detail in the examples of the present invention.

All the optimisation methods described above are based on optimising the ratio of the number of extracted anti-Stokes photons to the number of extracted Stokes photons, e.g. on obtaining the highest ratio or almost the highest ratio of the number of extracted anti-Stokes photons to the number of extracted Stokes photons. Almost the highest ratio of the number of extracted anti-Stokes photons to the number of extracted Stokes photons may be preferred over the highest ratio in case the highest ratio corresponds with a low total number of photons generated in these scattering processes. In other words, choosing a working point where the photon number ratio reaches a value close to a maximum instead of the maximum, might be useful e.g. in case the absolute photon numbers at the working point corresponding with the maximum photon number ratio are relatively low, e.g. substantially lower than for a photon number ratio that is almost maximal. The optimisation methods may be such that optimisation is performed until a predetermined ratio of the number of extracted anti-Stokes photons to the number of extracted Stokes photons is obtained. It also may be such that a scan of the complete or partial parameter range of the external parameter under consideration is performed, whereby the parameter value/values or parameter setting/settings resulting in the highest ratio or almost the highest ratio of the number of extracted anti-Stokes photons to the number of extracted Stokes photons is selected. Parameter settings thereby may refer to non-numerical parameter selections such as e.g. Gaussian beam or Bessel beam for the beam profile. Selection of parameter values or parameter settings may be done either systematic or at random.

In other words, the value or setting of an internal parameter is selected by searching a maximum or a value close to a maximum for the ratio of the number of extracted anti-Stokes photons to the number of extracted Stokes photons. This maximum may be a local maximum or it may be a global maximum. Besides optimisation of a single internal parameter, the same procedure may be applied to optimisation of a number of internal parameters or a number of internal and external parameters. Plural parameters may be optimised in one procedure, whereby the parameter space spanned by the different parameter ranges is studied. This second embodiment will be further illustrated by way of two examples. By optimising one or more parameters of the active-medium-based system, a design or set-up for an active-medium-based system is obtained. The method according to the present invention may be performed in an automated way, e.g. based on specific computer implemented algorithms, neural networks, etc.

In a second aspect, the present invention relates to an active-medium-based system that is adapted for thermal control based on radiative cooling using Raman scattering processes as described above. The active-medium-based systems thereby are adapted for being thermally controlled, e.g. using the methods for setting up as described in the first and second embodiments of the first aspect. The active-medium-based systems thereby are optimised in such a way that the ratio of the number of extracted anti-Stokes photons to the number of extracted Stokes photons reaches a maximum or a value close to a maximum. The active-medium-based systems thereby may have a configuration characterised by external parameters such as e.g. the incident pump power, the pump beam profile, the pump polarisation, the pump phase, the pump wavelength, the pump propagation direction, the pump propagation sense, the pump spectral linewidth, and if relevant for the active-medium-based system under consideration, the reflectivities of the cavity mirrors, the phase shift of the cavity mirrors, the radius of curvature of the cavity mirrors, the polarisation effect of the cavity mirrors, the distance or distances between the cavity mirrors, the angle or angles between the optical axes of the mirror sets, the power and beam profile of the Stokes input beam, the Stokes wavelength, the Stokes spectral linewidth, the polarisation and the phase of the Stokes input beam, the Stokes propagation direction and the Stokes propagation sense, the power and beam profile of the anti-Stokes input beam, the anti-Stokes wavelength, the anti-Stokes spectral linewidth, the polarisation and the phase of the anti-Stokes input beam, the anti-Stokes propagation direction and the anti-Stokes propagation sense, the ratios between the pump, Stokes and/or anti-Stokes input powers, the angles between the pump, Stokes and/or anti-Stokes input beams, the differences between the pump, Stokes and/or anti-Stokes phase, the differences between the pump, Stokes and/or anti-Stokes polarisation, the length of the input pulses, the temporal and spatial shape of the input pulses and the repetition rate of the input pulses, etc. such that an optimised ratio of the number of extracted anti-Stokes photons to the number of extracted Stokes photons is obtained. Next to external parameters, the configuration of such active-medium-based systems also may be characterised by internal parameters such as e.g. the Raman gain of the medium, the scattering linewidth of the medium, the optical losses of the medium, the length of the medium, the medium structure, the intrinsic phase mismatch of the medium, etc. or it may also comprise adding a compensating phase-matching or quasi-perfect-phase-matching part with or next to the active medium such that an optimised ratio of the number of extracted anti-Stokes photons to the number of extracted Stokes photons is obtained. Another internal parameter may be the initial temperature of the medium. In other words, the different elements such as e.g. the active medium, the cavity mirrors, the distance or distances between the cavity mirrors, the angle or angles between the optical axes of the mirror sets, and the optical input may be adapted such that several of these optimised parameters are obtained. The active medium may be selected and prepared such that the requirements on the Raman gain of the medium, the scattering linewidth of the medium, the optical losses of the medium, the length of the medium, the medium structure, and the intrinsic phase mismatch are fulfilled. Also a requirement on the initial temperature of the medium may be fulfilled. The mirrors may be selected such that the requirements on reflectivity for the mirrors, on the phase shift of the mirrors, on the radius of curvature of the mirrors and on the polarisation effect of the mirrors are fulfilled, and the mirror positioning may be selected such that the requirement on the distance or distances between the cavity mirrors and the requirement on the angle or angles between the optical axes of different mirror sets are fulfilled. The configuration may be selected such that the requirements for the angles between the pump input beam, the Stokes input beam and/or the anti-Stokes input beam, for the ratios between the pump input power, the Stokes input power and/or the anti-Stokes input power, for the differences between the pump, Stokes and/or anti-Stokes phase, and for the differences between the pump, Stokes and/or anti-Stokes polarisation are fulfilled. Furthermore, the pump system, the Stokes input system and/or the anti-Stokes input system may be selected or a controller may be provided such that the requirements on pump wavelength, on Stokes wavelength, on anti-Stokes wavelength, on pump beam profile, on Stokes beam profile, on anti-Stokes beam profile, on pump power, on Stokes input power, on anti-Stokes input power, on the pump spectral linewidth, on the Stokes spectral linewidth, on the anti-Stokes spectral linewidth, on the ratio between the pump power, Stokes input power and/or anti-Stokes input power, on pump polarisation, on Stokes polarisation, on anti-Stokes polarisation, on pump phase, on Stokes phase, on anti-Stokes phase, on pump propagation direction, on Stokes propagation direction, on anti-Stokes propagation direction, on pump propagation sense, on Stokes propagation sense, and on anti-Stokes propagation sense are fulfilled. A controller also may be provided that is adapted for controlling pulsing of the system such that the length, the temporal shape, the spatial shape and the repetition rate of the input pulses may meet a predefined requirement. Further possible characteristics are discussed below in more detail.

Concerning laser setups and oscillator setups in general, a broad range of configurations and pumping schemes are available for these setups. They may be side pumped or end pumped, they may be tunable or untuned, they may be frequency doubled or undoubted. Pumping energy can be delivered to the active medium by lenses, fibers, or configurations using both lenses and fibers, or in other ways. As shown in FIG. 5, a laser or oscillator has an active medium 100, such as e.g. a gaseous, liquid, solid, semiconductor or fibre-based Raman medium or an active medium comprising a Raman-active host which is doped with ions, which is placed in a cavity defined by a first 120 and second 130 opposing mirrors. The mirrors of the cavity can be discrete mirrors at a distance from the ends of the medium, or one or both of the mirrors may be a reflective coating applied to an end of the active medium. The cavity resonance may be regulated by e.g. locking it to a specific frequency with electro-optic and acousto-optic modulators, which are not shown in FIG. 5. The pump 110 is typically coupled to the cavity through coupling optics 140. The cavity may also optionally include a frequency doubler, which is not shown in FIG. 5.

Side-pumping provides the ability to distribute pumping energy along the length of the medium, thus minimizing fluence, and consequential optical damage to the crystal surface. A cylindrical lens can serve as the coupling optics, to direct the pumping radiation into the medium. End pumping may be an alternative to side-pumping, and a laser diode array may be used for such end-pumping, as well as for side-pumping. The medium can be configured to prevent oscillation between any of the faces of the medium, except along the axis perpendicular to the mirrors that define the laser cavity or oscillator cavity. In particular, in a side-pumping configuration, it is preferred to prevent oscillation between the side of the medium where the pumping radiation is introduced and the opposing side of the medium. Typically, this may be accomplished by making these two sides sufficiently nonparallel, e.g. by 5 degrees, so that oscillation does not occur between them. The ends of the medium which lie along the axis perpendicular to the mirrors are typically flat and parallel to each other and the mirrors.

Frequency doubling, if desired, typically may be achieved using a frequency doubling crystal disposed intra-cavity, to take advantage of the high intra-cavity intensities. Alternatively, the doubling crystal is disposed outside the laser cavity or oscillator cavity, or within a separate cavity. If tuning is desired, a tuning element, which is not shown in FIG. 5 can be inserted in the cavity at Brewster's angle between the active medium and the output mirror. This tuning element may be a birefringent tuning plate, a grating, or a prism for example. The active medium can have coatings to provide sufficient bandwidth to allow tuning over the desired wavelength range. Continuous tuning of the laser or oscillator can be achieved over the desired wavelength range by rotating the tuning element about its axis. In case pulsed operation is desired, a Q-switch or a mode-locking element, which are not shown in FIG. 5, can be inserted in the cavity, and other laser specifications or oscillator specifications such as the pumping method can be adapted.

If specifically the case of Raman lasers is considered, even more types of configurations and pumping schemes can be applied. An external resonator Raman laser, which basically consists of a cavity comprising a Raman-active medium, can be configured in the same ways as described above. One can also use an intra-cavity Raman laser configuration, in which the Raman-active medium is placed next to the active medium of the pump inside the resonator of the pump laser. This configuration utilizes the much higher intra-cavity power densities and lowers the threshold needed for triggering the Raman scattering processes. In case of coupled cavity Raman lasers, the setup can be considered as a subset of intra-cavity Raman lasers with separate resonators for the Stokes and anti-Stokes fields at one hand, and for the pump field on the other hand. This can offer practical advantages in comparison with standard intra-cavity Raman lasers in that the mirror coatings are now specified for maximum two wavelengths instead of three. These resonators are also well suited for special applications such as linewidth control or tuning, because the tuning elements can be placed in either the pump or Stokes-anti-Stokes cavity so that they affect maximum two optical fields instead of three. Besides the linear configuration, one can also use a folded configuration for coupled cavity Raman lasers.

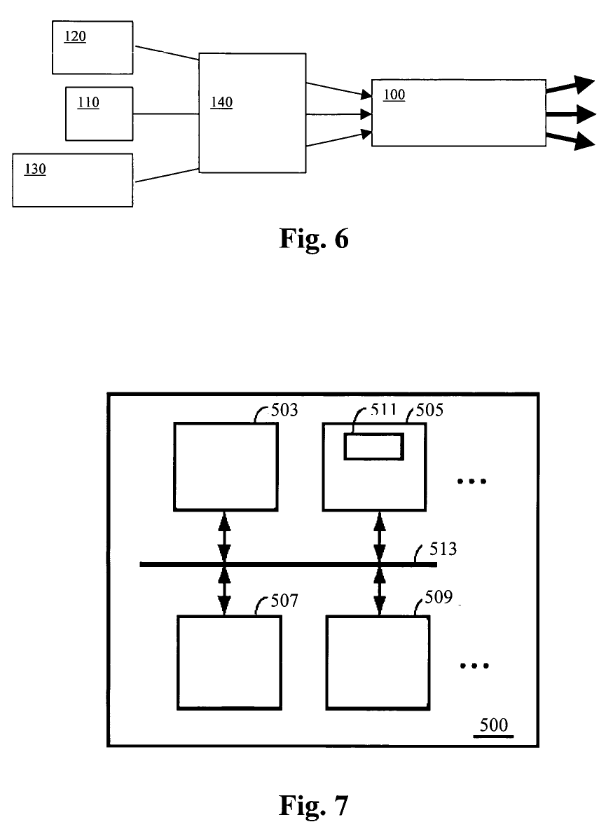

Concerning amplifiers, generators and converters in general—a generic setup for these active-medium-based systems is shown in FIG. 6—, the same pumping schemes and the same configurations as described above can be used, as far as they do not concern laser-related or oscillator-related aspects such as cavity mirrors for example.

By way of example, adaptation of different system parameters such that the ratio of the number of extracted anti-Stokes photons to the number of extracted Stokes photons reaches a maximum or a value close to a maximum will now be described in more detail.

In case of a continuous-wave or pulsed laser or oscillator setup, as shown in FIG. 5, and in case of a continuous-wave or pulsed amplifier, converter or generator setup as shown in FIG. 6, this optimisation of the photon number ratio may be performed by adapting the incident pump power, the pump beam profile, the pump polarisation, the pump phase, the pump wavelength, the pump propagation direction, the pump propagation sense, and the pump spectral linewidth of the pump source 110. One can adapt the photon number ratio also by selecting an active medium 100 and thus by selecting the Raman gain, and by adapting the optical losses of the medium, the medium length, the scattering linewidth of the medium, and the structure of the medium. Another parameter of the active medium which may be modified for adapting the photon number ratio, may be the initial temperature of the medium. Furthermore, the photon number ratio may also be adapted by changing the intrinsic phase mismatch of the active medium 100. In case of a birefringent material comprised in a type of geometrical configuration, this can be realised not only by adapting e.g. the pump, Stokes and anti-Stokes wavelengths and powers, but also by adapting the features of the geometrical configuration. In case of a medium of which the cross sections perpendicular to the optical axis contain regions of different index of refraction, optimisation by changing the intrinsic phase mismatch of the medium can be obtained by adapting e.g. the pump, Stokes and anti-Stokes wavelengths and powers, the features of the regions of different index of refraction, and also the gas pressure in case the medium contains an air fraction that is filled with a gaseous Raman-active material. Still another way to change the intrinsic phase mismatch of the medium for optimising the photon number ratio, is by evoking a mechanism that adapts the material dispersion, such as e.g. electromagnetically induced transparency. The phenomenon of electromagnetically induced transparency can be evoked in a medium with narrow scattering linewidths or in Raman gases of which the Doppler-broadened linewidths are narrowed down by a line narrowing mechanism, such as the Dicke line narrowing effect for example. The line narrowing mechanism also can be applied for an active medium that is e.g. solid. In case the present invention of thermal control is applied to a continuous-wave or pulsed laser or oscillator setup, as shown in FIG. 5, the optimisation of the photon number ratio can also be performed by adapting the reflectivities at the relevant wavelengths, the phase shift, the radius of curvature, and the polarisation effect of the cavity mirrors 120 and 130, and also by optimising the distance between the cavity mirrors. In case not only one set of cavity mirrors 120 and 130, but several mirror sets are used for obtaining the selected reflectivity values at the pump, Stokes and anti-Stokes wavelengths, the distance between the cavity mirrors of each set can be optimised, and also the angle or angles between the optical axes of the mirror sets can be adapted. One can also add a compensating phase-matching or quasi-perfect-phase-matching part 150 in the cavity with or next to the active medium.

In case the present invention of thermal control is applied to a continuous-wave or pulsed amplifier, converter or generator setup, as shown in FIG. 6, optimising the photon number ratio can also be performed by adapting the beam profile of the Stokes input beam 120 and/or of the anti-Stokes input beam 130, and by optimising the Stokes input power, the anti-Stokes input power, and/or the ratios between the pump, Stokes and/or anti-Stokes input powers. One can also adapt the Stokes polarisation, the anti-Stokes polarisation, the Stokes spectral linewidth, the anti-Stokes spectral linewidth, the Stokes phase, the anti-Stokes phase, the Stokes propagation direction, the anti-Stokes propagation direction, the Stokes propagation sense, the anti-Stokes propagation sense, the differences between the pump, Stokes and/or anti-Stokes phase, the differences between the pump, Stokes and/or anti-Stokes polarisation, and the angles between the pump input beam, the Stokes input beam and/or the anti-Stokes input beam.

In case the present invention of thermal control is applied to a laser, oscillator, amplifier, generator or converter setup with pulsed operation, the optimisation of the photon number ratio can also be performed by adapting the length, the temporal shape, the spatial shape and the repetition rate of the input pulses.

Although the restrictions on the active medium for use of the above described methods are small, depending on the type of active medium, one or several parameters to be optimised may be selected, and vice versa, depending on the optimisation method or methods one wants to use, the active medium could be selected. The methods of thermal control described in the first and second embodiments of the first aspect can be applied to many different active materials. For thermally controlling active-medium-based systems using the methods described in the first and second embodiments of the first aspect, the active media in these systems may be e.g. gaseous, liquid, solid, semiconductor or fibre-based Raman-active media such as e.g. hydrogen gas, Rhodamine 6G laser dye, Ba(NO₃)₂, silicon, and silica fibre, respectively, but it may also be active media comprising a Raman-active host which is doped with ions, such as Nd³⁺:KGd(WO₄)₂ for example. Special examples of such active-medium-based systems are Raman lasers, which are laser setups comprising Raman-active media that are responsible for the generation of a frequency shifted laser output through Raman scattering interactions with the incoming pump radiation. The recent development of Raman lasers based on e.g. semiconductor materials, such as silicon for example, and on e.g. semiconductor compounds, such as quantum cascade active media made of AlInAs and GaInAs layers for example, has opened up many application possibilities in several interdisciplinary fields where photonics and electronics come together. Especially the Raman laser based on silicon, a material which is widely used in the semiconductor industry, has drawn much attention, since this was the first time that efficient lasing with silicon as active medium was achieved.

In a third aspect, the present invention also relates to a controller adapted for controlling parameters of an active-medium-based system such that it is thermally controlled based on radiative cooling using Raman scattering processes as described above. The controller may control different parameters of an active-medium-based system such that the ratio of the number of extracted anti-Stokes photons to the number of extracted Stokes photons reaches a maximum or a value close to a maximum. Such a controller may be an electronic control system for use with an active-medium-based system in accordance with the present invention. The controller may control specific parameters of the active-medium-based system, such as e.g. the pump wavelength, the Stokes wavelength, the anti-Stokes wavelength, the pump polarisation, the Stokes polarisation, the anti-Stokes polarisation, the pump phase, the Stokes phase, the anti-Stokes phase, the pump propagation direction, the Stokes propagation direction, the anti-Stokes propagation direction, the pump propagation sense, the Stokes propagation sense, the anti-Stokes propagation sense, the pump spectral linewidth, the Stokes spectral linewidth, the anti-Stokes spectral linewidth, the pump input power, the Stokes input power, the anti-Stokes input power, the ratios between the pump input power, Stokes input power and/or anti-Stokes input power, the angles between the pump input beam, the Stokes input beam and/or the anti-Stokes input beam, the differences between the pump, Stokes and/or anti-Stokes phase, the differences between the pump, Stokes and/or anti-Stokes polarisation, the polarisation effect of the cavity mirrors, the distance or distances between the cavity mirrors, the angle or angles between the optical axes of the mirror sets, the pulse conditions if a system is operated in pulsed mode, the optical losses of the medium, and/or the gas pressure in case the medium contains a gaseous component. The controller may also control the initial temperature of the medium. The controller may include a computing device, e.g. microprocessor, for instance it may be a micro-controller. In particular, it may include a programmable controller, for instance a programmable digital logic device such as a Programmable Array Logic (PAL), a Programmable Logic Array, a Programmable Gate Array, especially a Field Programmable Gate Array (FPGA). The use of an FPGA allows subsequent programming of the active-medium-based device, e.g. by downloading the required settings of the FPGA. It may also comprise a memory for storing predetermined parameter values or parameter settings to be realised by the system and/or reading and/or writing capacities for reading/writing information about these parameter values or parameter settings. Parameter settings thereby may refer to non-numerical parameter selections such as e.g. Gaussian beam or Bessel beam for the beam profile.

In a further aspect, the present invention furthermore relates to processing systems for performing methods for setting up thermally controlled active-medium-based systems as described in the first and second embodiments of the first aspect. Such methods may be completely or partly implemented in a processing system 500 such as shown in FIG. 7. FIG. 7 shows one configuration of processing system 500 that includes at least one programmable processor 503 coupled to a memory subsystem 505 that includes at least one form of memory, e.g. RAM, ROM, and so forth. A storage subsystem 507 may be included that has at least one disk drive and/or CD-ROM drive and/or DVD drive. In some implementations, a display system, a keyboard, and a pointing device may be included as part of a user interface subsystem 509 to provide for a user to manually input information. Ports for inputting and outputting data also may be included. More elements such as network connections, interfaces to various devices, and so forth, may be included, but are not illustrated in FIG. 7. The various elements of the processing system 500 may be coupled in various ways, including via a bus subsystem 513 shown in FIG. 7 for simplicity as a single bus, but will be understood to those in the art to include a system of at least one bus. The memory of the memory subsystem 505 may at some time hold part or all, in either case shown as 511, of a set of instructions that when executed on the processing system 500 implement the step or steps of the method embodiments described herein. Thus, while a processing system 500 such as shown in FIG. 7 is prior art, a system that includes the instructions to implement aspects of the present invention is not prior art, and therefore FIG. 7 is not labelled as prior art.

It is to be noted that the processor 503 or processors may be a general purpose, or a special purpose processor, and may be for inclusion in a device, e.g. a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product tangibly embodied in a carrier medium carrying machine-readable code for execution by a programmable processor. Method steps of aspects of the invention may be performed by a programmable processor executing instructions to perform functions of those aspects of the invention, e.g. by operating on input data and generating output data. The present invention therefore also includes a computer program product which provides the functionality of the method for designing active-medium-based systems or part thereof according to the present invention when executed on a computing device. Further, the present invention includes a data carrier such as a CD-ROM, DVD or a diskette which stores the computer product in a machine readable form and which executes at least one of the methods of the invention when executed on a computing device. Nowadays, such software is often offered on the Internet, hence the present invention includes transmitting the computer product according to the present invention over a local or wide area network.

It is to be understood that although preferred embodiments, specific constructions and configurations, as well as materials, have been discussed herein for devices according to the present invention, various changes or modifications in form and detail may be made without departing from the scope and spirit of this invention. For example, whereas in the above embodiments methods for setting up active-medium-based systems and active-medium-based systems are described that are thermally controlled based on radiative cooling using Raman scattering processes, the present invention also relates to methods for generating radiation in a thermally controlled way. Such methods typically are based on the same principles as described above. They typically may comprise providing generation of radiation and controlling the efficiencies of Raman scattering processes during generation of radiation. The latter may e.g. be performed by controlling at least one of, some of or all of the system parameters, such as the incident pump power, the pump beam profile, the pump wavelength, the pump polarisation, the pump phase, the pump propagation direction, the pump propagation sense, the pump spectral linewidth, the pulse conditions if a systems is operated in pulsed mode, the Stokes wavelength, the anti-Stokes wavelength, the polarisation and phase of the Stokes input beam, the polarisation and phase of the anti-Stokes input beam, the Stokes propagation direction and sense, the anti-Stokes propagation direction and sense, the Stokes spectral linewidth, the anti-Stokes spectral linewidth, the power and the beam profile of the Stokes input beam, the power and the beam profile of the anti-Stokes input beam, the ratios between the pump input power, Stokes input power and/or anti-Stokes input power, the angles between the pump input beam, the Stokes input beam and/or the anti-Stokes input beam, the differences between the pump, Stokes and/or anti-Stokes phase, the differences between the pump, Stokes and/or anti-Stokes polarisation, the reflectivities of the cavity mirrors, the phase shift of the cavity mirrors, the polarisation effect of the cavity mirrors, the distance or distances between the cavity mirrors, the angle or angles between the optical axes of the mirror sets, the optical losses of the medium, and/or the gas pressure in case the medium contains a gaseous component. Another parameter that may be controlled, may be the initial temperature of the medium.

Active-medium-based systems as described in the second aspect are especially suitable for performing such methods.

By way of illustration, the invention not being limited thereto, numerical simulation results will further be presented illustrating the features and advantages of methods and systems using thermal control according to the present invention. In a first example, a system is described whereby thermal control is performed by adjusting the mirror reflectivities at one wavelength and by adjusting the phase mismatch of the medium. In a second example, a system is described whereby thermal control is performed by adjusting the angle of the incident pump beam and Stokes beam and by adjusting the length of the medium.

In a first example, a continuous-wave or quasi-continuous-wave Raman laser emitting both Stokes- and anti-Stokes-scattered photons is considered. By optically pumping a Raman laser, the intra-cavity pump power will start to increase until this power level is high enough to trigger Raman scattering interactions inside the Raman medium, and this will result in the generation of a frequency shifted laser output.

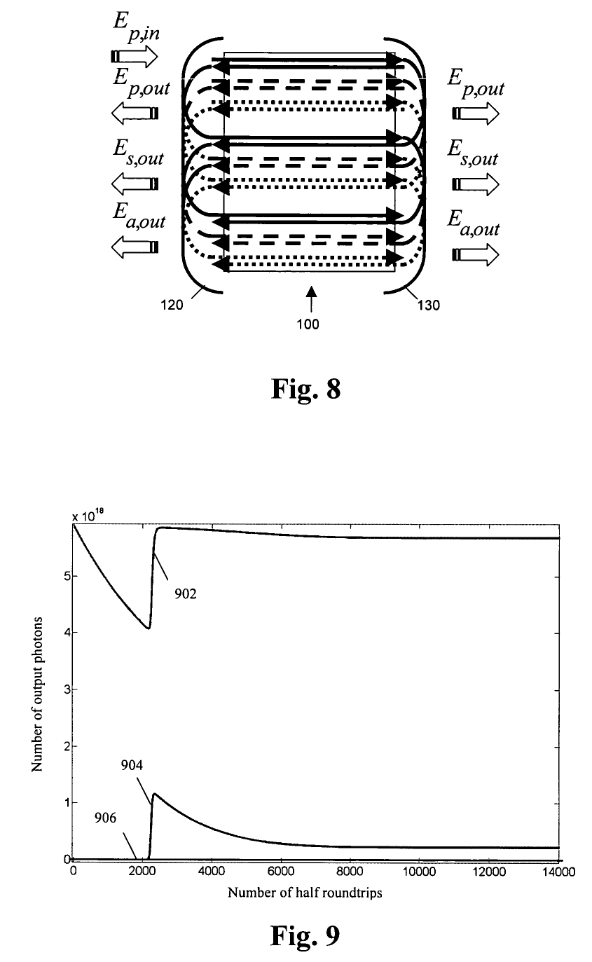

To model the build up process of the Stokes and anti-Stokes powers for a continuous-wave or quasi-continuous-wave Raman laser, use is made of a so-called iterative resonator model. This model is based on a set of propagation equations for forward- and backward-propagating pump, Stokes and anti-Stokes electromagnetic waves, and these equations contain all the relevant interaction terms for Stimulated Stokes Raman Scattering, Stimulated Anti-Stokes Raman Scattering and Coherent Anti-Stokes Raman Scattering. The basic principle of this model is schematically shown in FIG. 8, indicating the pump wave Eₚ, the Stokes wave Eₛ and the anti-Stokes wave Eₐ. In this FIG. 8 the subscript ‘in’ indicates the incident wave, and the subscripts ‘out’ indicate the waves that are coupled out of the laser cavity. The arrows inside the cavity represent the forward and backward propagation of the intracavity waves.

For modelling a pumped Raman laser system according to the principles of the iterative resonator model, first the effect of the incoming pump energy propagating from the beginning to the end of the cavity is calculated—this unit of propagation distance will be referred to as half roundtrip—by solving the pump propagation equations, the Stokes propagation equations and the anti-Stokes propagation equations over the cavity length with boundary conditions equal to the incoming pump power and typical Stokes and anti-Stokes spontaneous scattering powers, respectively. Once these longitudinal power distributions are known, the output powers after the first half roundtrip can be determined by calculating how much of the intra-cavity power at the cavity edges is transmitted by the cavity mirrors. The power that is reflected by the cavity mirrors in combination with the new incoming pump power, form the new boundary conditions for solving the propagation equations for the second half roundtrip, and so on. After a number of half roundtrips, there no longer exists a difference between the power distributions calculated in the current half roundtrip, and the corresponding distributions obtained in the previous half roundtrip. At that point, the steady state regime is reached, and the sequence of simulation results for the half roundtrips that precede the steady state situation can be considered as accurate and true data on how the Stokes and anti-Stokes powers are built up in time starting from spontaneous scattering signals for time scales sufficiently larger than the halt roundtrip time.

Since the iterative resonator model takes into account the longitudinal power distributions inside the cavity, which can exhibit quite strong gradients especially in case of low mirror reflectivities, the iterative resonator model obeys for both high and low reflectivity values the conservation of number of photons. The model also distinguishes forward field propagation from backward field propagation inside the laser cavity. This directional information is important since in case of Stimulated Stokes Raman Scattering and Stimulated Anti-Stokes Raman Scattering, the incident photons are scattered in both the co- and counter-propagating direction, while Coherent Anti-Stokes Raman Scattering is based on photon scattering only in the co-propagating direction. It is an advantage of the iterative resonator model as described above that it incorporates these two aspects, being the longitudinal power distributions and the directional propagation information, which is e.g. not the case in the earlier developed rate equation model for Raman lasers. As a result, the iterative resonator model produces results with a higher accuracy, and therefore this model is preferred over the rate equation model.

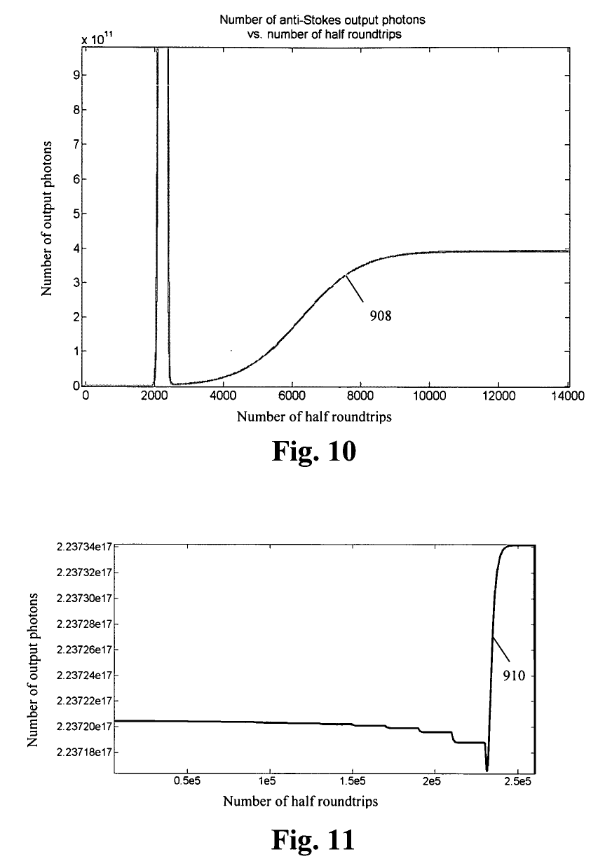

As a concrete example of a Raman laser which can be modelled by the use of the iterative resonator model, a continuous-wave Raman laser is considered where the active medium is a Raman cell filled with hydrogen gas at a pressure of 30 atm, exhibiting a Raman gain of 4.42 cm/GW for the hydrogen vibrational transition of 4155 cm⁻¹. The exemplary Raman laser is pumped by a frequency-doubled Nd:YAG laser emitting 2 W of optical power. The spectral linewidth of the pump laser is considered to be infinitesimally small. The pump, Stokes and anti-Stokes wavelengths are 532 nm, 683 nm and 436 nm, respectively, and the phase mismatch for Coherent Anti-Stokes Raman Scattering equals 3.84 rad/cm. The propagation losses in the hydrogen cell are negligible for all three wavelengths. The cavity length and medium length equal approximately 7.7 cm, the curvature of the two mirrors surrounding the medium is 25 cm and the confocal parameter of the pump beam equals 18 cm. The cavity resonance is regulated in such a way that we may assume that the cavity is perfectly resonant for the pump wavelength as well as for the Stokes and the anti-Stokes wavelengths. The reflectivities of the front and back cavity mirrors are 0.9998 at the pump wavelength, 0.9995 at the Stokes wavelength and 0.8898 at the anti-Stokes wavelength. The numerical results of the iterative resonator model for the evolution of the number of pump output photons 902, the number of Stokes output photons 904 and the number of anti-Stokes output photons 906 through the front and back mirrors, and a more detailed representation of the evolution of the number of anti-Stokes output photons 908 through the front and back mirrors are shown in FIG. 9 and FIG. 10, respectively.

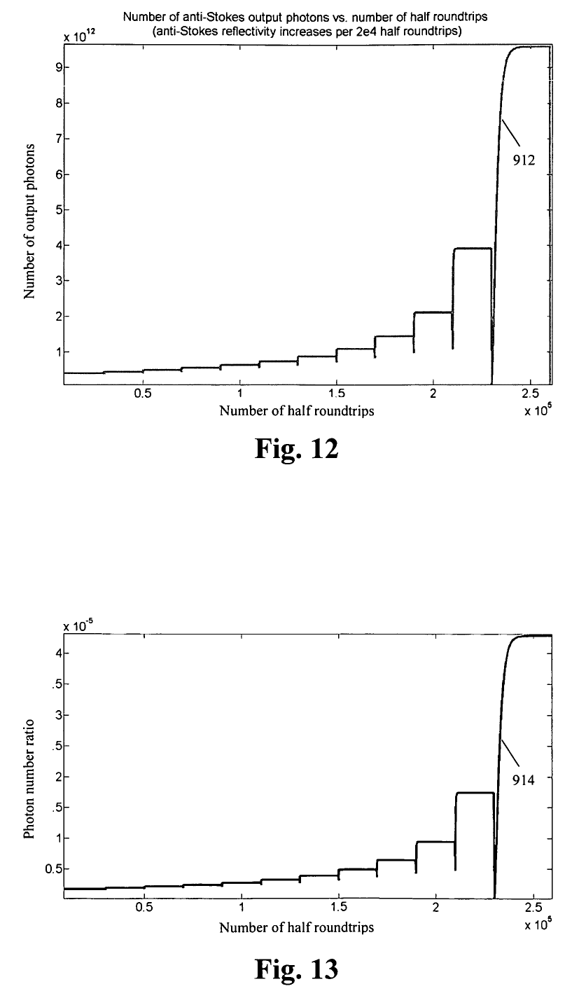

To optimise the ratio of the number of extracted anti-Stokes photons to the number of extracted Stokes photons, the anti-Stokes mirror reflectivity is optimised by scanning the parameter space of the anti-Stokes mirror reflectivity, while keeping the pump and Stokes mirror reflectivities fixed. FIG. 11 and FIG. 12 show how the number of Stokes output photons 910 and the number of anti-Stokes output photons 912 respectively, change as a function of the number of half roundtrips, whereby for every 2×10⁴ half roundtrips the anti-Stokes mirror reflectivity increases with a value of 0.01 and in this way evolves from 0.8898 to 0.9998. In other words, FIG. 11 and FIG. 12 show the number of Stokes output photons respectively the number of anti-Stokes output photons as a function of different anti-Stokes mirror reflectivities. It is to be noted here that besides these Stokes and anti-Stokes output photons through the front and back mirrors, no other Stokes and anti-Stokes photons are extracted due to e.g. propagation losses since the latter are negligible in this case. In FIG. 13, the changes of the ratio 914 of the number of extracted anti-Stokes photons to the number of extracted Stokes photons are shown, indicating that in the reflectivity range from 0.8898 to 0.9998, it is best to choose an anti-Stokes mirror reflectivity of 0.9998 for optimising this photon number ratio. The resulting photon number ratio for this reflectivity value is 4.3×10⁻⁵.

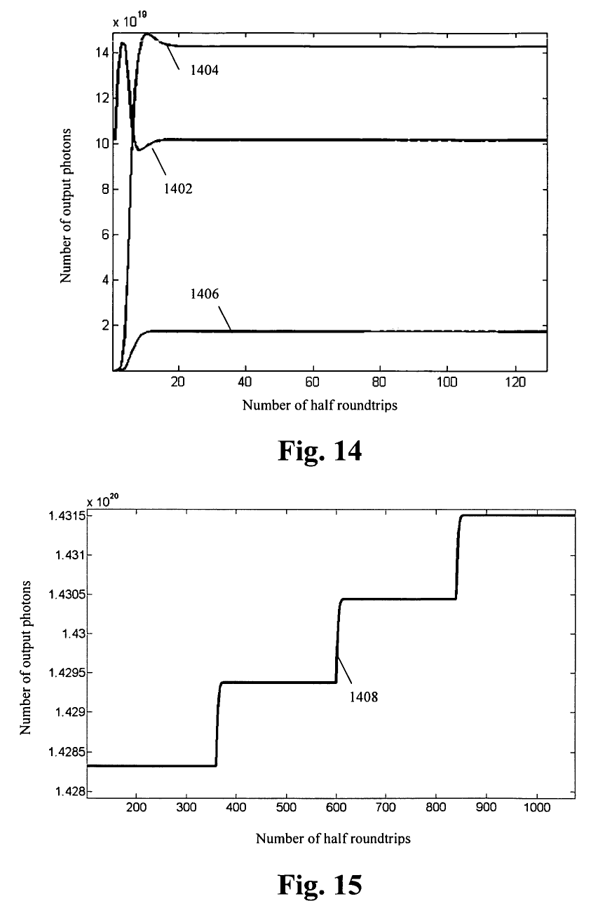

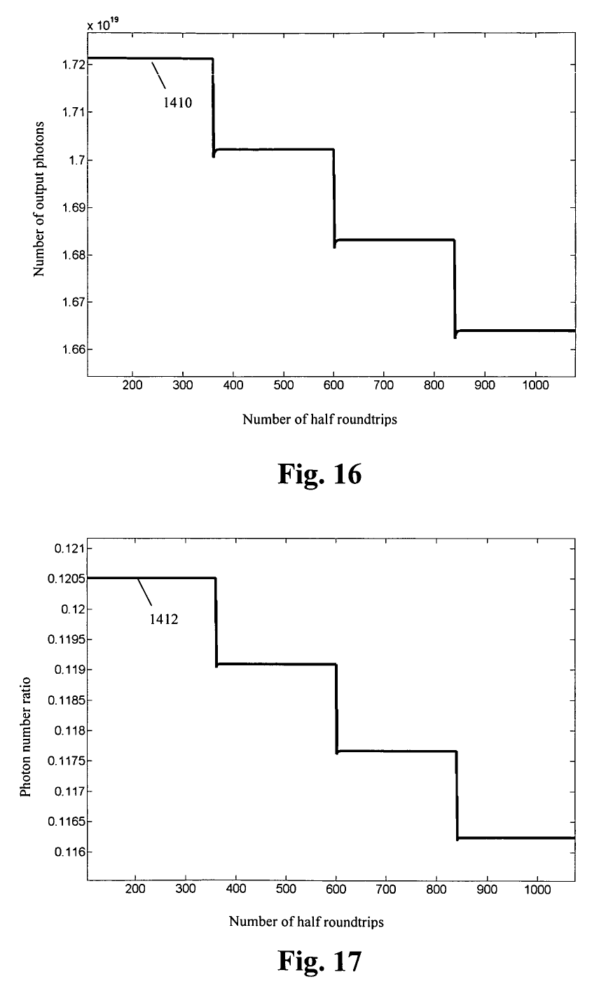

To increase this low photon number ratio, one can combine the reflectivity optimisation with a change in the intrinsic phase mismatch of the medium. To illustrate this, a 50 cm-long, hollow-core photonic crystal fibre is considered which is filled with hydrogen gas at room temperature. The hydrogen pressure is tuned to a value of about 4 atm where the Dicke line narrowing effect, known to the person skilled in the art, occurs for the hydrogen vibrational transition of 4155 cm⁻¹. This allows evoking electromagnetically induced transparency, and as a result, perfect phase matching between pump, Stokes and anti-Stokes waves becomes possible. The Raman gain in this exemplary configuration for the hydrogen vibrational transition of 4155 cm⁻¹ is 2.2 cm/GW. The pump laser in the present example is a frequency doubled quasi-continuous-wave Nd:YAG laser emitting 140 ns-long pulses at 532 nm. The energy of the pulses is 17.5 μJ and the repetition rate is 4 kHz. This results in a peak power of 125 W. The spectral linewidth of the pump laser is considered to be infinitesimally small. The Stokes and anti-Stokes wavelengths generated in the hydrogen-filled photonic crystal fibre are 683 nm and 436 nm, respectively. The fibre is aligned between two cavity mirrors, both exhibiting a reflectivity of 0.30, 0.30 and 0.20 at the pump, Stokes and anti-Stokes wavelengths, respectively. The fibre loss at all three wavelengths is 3 dB/m. FIG. 14 shows the evolution of the number of pump output photons 1402, the number of Stokes output photons 1404 and the number of anti-Stokes output photons 1406 through the front and back mirrors, for this specific configuration where perfect phase matching is realised. For a configuration exhibiting a perfect phase matching, the ratio of the number of extracted anti-Stokes photons to the number of extracted Stokes photons may be optimised by scanning the parameter space of the anti-Stokes mirror reflectivity, while keeping the pump and Stokes mirror reflectivities fixed. FIG. 15 and FIG. 16 show how the number of Stokes output photons 1408 and the number of anti-Stokes output photons 1410, respectively, change as a function of the number of half roundtrips, whereby for every 250 half roundtrips the anti-Stokes mirror reflectivity increases with a value of 0.01 and in this way evolves from 0.2 to 0.23. In other words, FIG. 15 and FIG. 16 show the number of Stokes output photons respectively the number of anti-Stokes output photons as a function of different anti-Stokes mirror reflectivities. In FIG. 17, the corresponding changes of the ratio 1412 of the number of extracted anti-Stokes photons through the front and back mirrors to the number of extracted Stokes photons through the front and back mirrors are shown, indicating that in the reflectivity range from 0.2 to 023, it is best to choose an anti-Stokes mirror reflectivity of 0.2 for maximizing this photon number ratio. The resulting photon number ratio for this reflectivity value is 0.12, which is a much higher ratio than 4.3×10⁻⁵. It is to be noted here that besides the extraction of Stokes and anti-Stokes photons through the front and back mirrors, there is also an extraction of Stokes and anti-Stokes photons due to the fibre loss. When taking into account also the latter photons, one finds for an anti-Stokes mirror reflectivity of 0.2 that the ratio of the total number of extracted anti-Stokes photons to the total number of extracted Stokes photons is equal to 0.13.

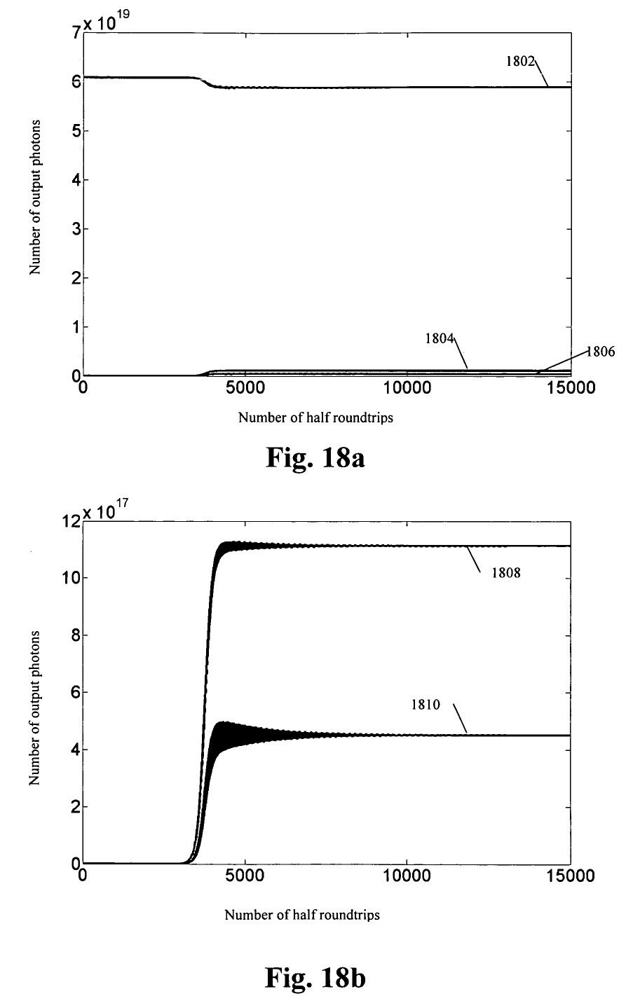

This example demonstrates the optimisation of a combination of one external parameter, i.e. the mirror reflectivities, and one internal parameter, i.e. the intrinsic phase mismatch, however, other external and/or internal parameters can be optimised in an analogous way. One can consider for example a hydrogen-based Raman laser consisting of a 20 cm-long hollow-core photonic crystal fiber that is filled with hydrogen and spliced at both sides to a piece of standard fiber that contains a Bragg grating. As in the previous case, also here phase matching has been realized, but this time by optimizing the geometrical configuration of the medium e.g. by optimizing the cross-sectional structure of the fibre. Besides optimizing the intrinsic phase mismatch of the medium for enhancing the photon number ratio, one can e.g. choose the pump source so that the spectral linewidth of the pump source is also optimized for enhancing the photon number ratio. From this point of view, a suitable pump source is e.g. a 30 W continuous-wave frequency-doubled Nd:YAG laser that emits radiation featuring a wavelength of 532 nm and a spectral linewidth of 2 GHz. The remaining specifications of the setup are as follows: the Raman gain of the hydrogen-based Raman laser equals 2.95×10⁻⁹ cm/W for the hydrogen vibrational transition of 4155 cm⁻¹ and the scattering linewidth of the medium is equal to 650 MHz. The Stokes and anti-Stokes wavelengths generated in the hydrogen-purged photonic crystal fibre are 683 nm and 436 nm, respectively. The modal effective area of the medium is 80 (micron)². The fibre loss at all three wavelengths equals 0.01 dB/m and the splice losses are 0.6 dB. For these parameter values, an optimization of the mirror reflectivities for enhancing the photon number ratio results in the following reflectivities for the front and back cavity mirrors: reflectivities of 0 at the pump wavelength, reflectivities of 0.6 at the Stokes wavelength and reflectivities of 0 at the anti-Stokes wavelength. The numerical results of the iterative resonator model for the evolution of the number of pump output photons 1802, the number of Stokes output photons 1804 and the number of anti-Stokes output photons 1806 through the front and back mirrors, and a more detailed representation of the evolution of the number of Stokes output photons 1808 and anti-Stokes output photons 1810 through the front and back mirrors are shown in FIG. 18a and FIG. 18b, respectively. Taking into account the output Stokes and anti-Stokes photons through the front and back mirrors and also the Stokes and anti-Stokes photons extracted due to the fibre loss and the splice losses, one obtains for this setup a photon number ratio of 0.30, which is a large value.

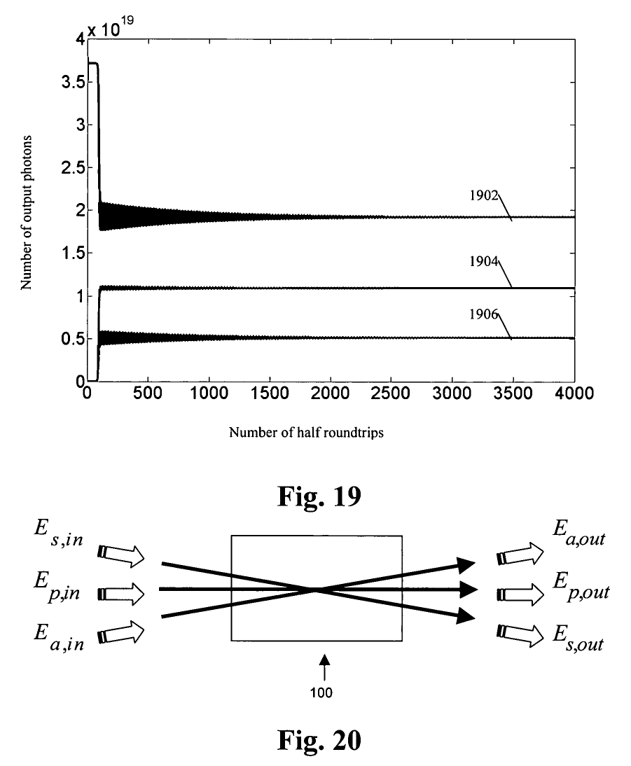

When performing the same optimizations as in the previous paragraph but this time for another Raman medium, it is possible to obtain an even higher photon number ratio. One can consider for example a silicon-based Raman laser, more specifically a silicon-on-insulator waveguide Raman laser in which phase matching has been realized by optimizing the geometrical configuration of the waveguide. The pump source is a 5 W continuous-wave fiber laser that emits radiation featuring a wavelength of 2.7 micron and a spectral linewidth of 300 GHz. Pumping silicon-based Raman lasers at a mid-infrared wavelength has several advantages, such as the absence of two-photon absorption and free carrier absorption. The remaining specifications of the setup are as follows: the length of the silicon-on-insulator waveguide is 2.5 cm. The Raman gain of the silicon-based Raman laser equals 1.6×10⁻⁸ cm/W for the material transition of 520 cm⁻¹ and the scattering linewidth of the medium is equal to 105 GHz. The Stokes and anti-Stokes wavelengths generated in the silicon medium are 3.14 micron and 2.37 micron, respectively. The modal effective area of the medium is 3 (micron)². The loss in the silicon medium at all three wavelengths equals 1 dB/cm. The reflectivities of the front and back facets of the waveguide are 0.05 at the pump wavelength, 0.45 at the Stokes wavelength and 0 at the anti-Stokes wavelength. The numerical results of the iterative resonator model for the evolution of the number of pump output photons 1902, the number of Stokes output photons 1904 and the number of anti-Stokes output photons 1906 through the front and back mirrors are shown in FIG. 19. Taking into account the output Stokes and anti-Stokes photons through the front and back mirrors and also the Stokes and anti-Stokes photons extracted due to the loss in the silicon medium, one obtains for this setup a photon number ratio of 0.35.

In a second example, another model different from the iterative resonator model is used. Although the iterative resonator model described in the first example is a very useful tool for describing how continuous-wave or quasi-continuous-wave pump signals are being converted to Stokes- and anti-Stokes-scattered radiation, another type of model is needed to investigate transient Raman scattering phenomena. One speaks of transient scattering in case the pump, Stokes and/or anti-Stokes pulses in the medium are short in comparison with the collisional de-excitation time of the medium. As a result, the material excitation can not be considered as time-independent as is the case for continuous-wave signals or for long pulses, and therefore, one needs to include an additional equation describing the evolution in time of the material excitation for modelling such transient scattering phenomena.

For example, an anti-Stokes Raman converter may be considered where the incident pump and Stokes pulses are short in comparison with the collisional de-excitation time of the converter's medium. To model such a Raman converter, a so-called numerical single-pass transient model is used. This model accurately calculates the growth or decrease of the Stokes pulses, anti-Stokes pulses and the material excitation along the medium and this numerical single-pass transient model also takes into account the pump pulse depletion. The basic principle of this model, which can also be used for modelling Raman amplifiers and Raman generators, is schematically shown in FIG. 20. In this FIG. 20 the subscripts ‘in’ indicate the incident electromagnetic waves, the subscripts ‘out’ indicate the electromagnetic waves that are coupled out of the amplifier, generator or converter. The pump waves Eₚ, the Stokes waves Eₛ and the anti-Stokes waves Eₐ are also indicated. It is an advantage of the numerical single-pass transient model as described above that it incorporates the depletion of the pump pulses, which is e.g. not the case in the earlier developed analytic solution for pulsed Raman amplifiers, generators and converters. As a result, the numerical single-pass transient model produces results with a higher accuracy, and therefore this model is preferred over the analytic solution.

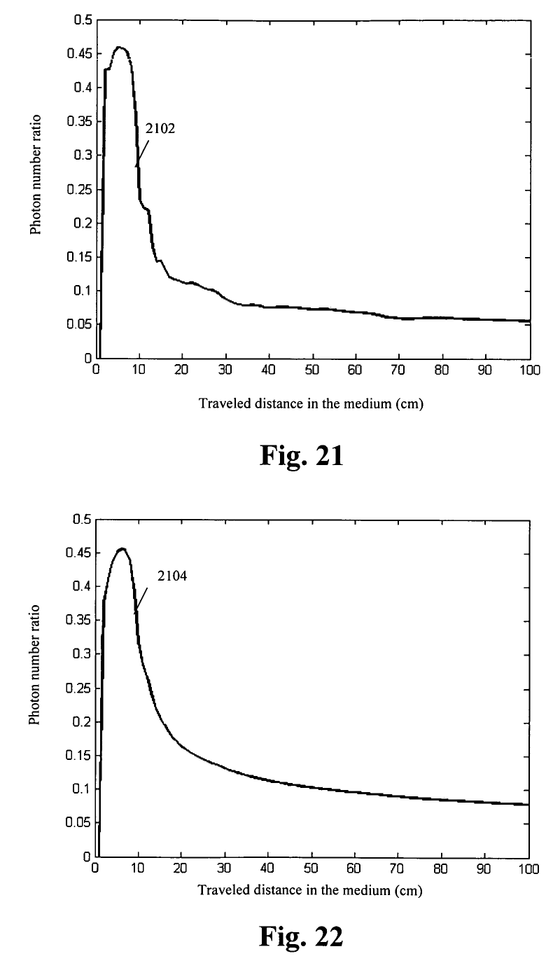

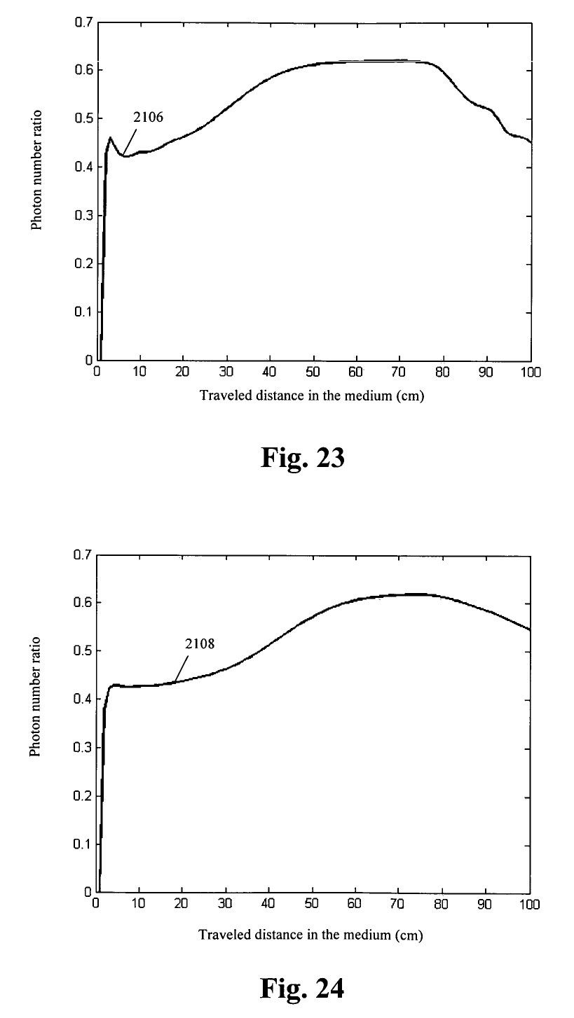

The specifications of an exemplary Raman converter considered in this second example, are as follows: the Raman-active medium is a 1 m-long cell in which hydrogen gas is compressed to a pressure of 10 atm, yielding a collisional de-excitation time of 633 ps and a Raman gain of 3 cm/GW for the hydrogen vibrational transition of 4155 cm⁻¹. The Raman converter is excited by a pump pulse at 532 nm and a Stokes pulse at 683 nm, both with a pulse length of 40 ps. The wavelength of the generated anti-Stokes pulses is 436 nm. The propagation losses in the hydrogen cell are negligible for all three wavelengths. Also the backscattering efficiency, i.e. the efficiency of the scattering processes in the counter-propagating direction, is considered to be negligibly small. The pump laser is a frequency-doubled Nd:YAG laser, the output beam of which is split up by a beamsplitter in a first beam that directly delivers the pump pulses to the anti-Stokes Raman converter, and in a second beam that passes through a Stokes seed generator to generate the Stokes input pulses for the anti-Stokes converter. The pump pulse has a maximum intensity of 0.8 GW/cm² and the maximum Stokes pulse intensity is 2.5×10⁻⁵*(0.8 GW/cm²)=20 kW/cm², which is a very small Stokes input intensity. The direction of the Stokes seed beam is slightly crossed compared to the incident pump beam in such a way that there is a smaller phase mismatch for Coherent Anti-Stokes Raman Scattering than in case both the pump and Stokes beams propagate along the same direction. In case the remaining phase mismatch is still 500 mrad/cm, the ratio 2102 of the number of extracted anti-Stokes photons to the number of extracted Stokes photons, calculated by the numerical single-pass transient model, evolves along the medium as shown in FIG. 21. The evolution along the medium of the ratio 2104 of the accumulated number of extracted anti-Stokes photons to the accumulated number of extracted Stokes photons is shown in FIG. 22. However, when the angle between the pump input beam and the Stokes input beam is optimised until a remaining phase mismatch of e.g. 40 mrad/cm is obtained, the numerical single-pass transient model calculates a photon number ratio 2106 that changes along the medium length as shown in FIG. 23. Here, the ratio 2108 of the accumulated number of extracted anti-Stokes photons to the accumulated number of extracted Stokes photons varies along the medium as shown in FIG. 24. If FIG. 22 is compared with FIG. 24, it can be seen that the ratio of the accumulated number of extracted anti-Stokes photons to the accumulated number of extracted Stokes photons at the end of the medium is much higher for FIG. 24, but at the same time, it can be seen that this ratio could be increased even more by adapting the length of the medium. The same reasoning can be made for the photon number ratios in FIG. 21 and FIG. 23 of the non-accumulated numbers of extracted photons. This length optimisation comprises truncating or extending the medium length so that the ratio of the accumulated/non-accumulated number of extracted anti-Stokes photons to the accumulated/non-accumulated number of extracted Stokes photons at the end of the medium reaches a maximum. In the case of FIG. 24, the medium length could be optimised by truncating it at a distance of 0.74 m, which would result in a very high ratio of accumulated photon numbers equal to 0.62 at the end of the medium. In the case of FIG. 23, the medium length could be optimised by truncating it at a distance of 0.68 m, which would also result in a value of 0.62 for the ratio of non-accumulated photon numbers. The latter result, which is obtained from FIG. 23, is more accurate than the result obtained from FIG. 24 if one wants to determine the photon number ratio incorporating all Stokes and anti-Stokes photons extracted from a real-life converter. To incorporate all extracted Stokes and anti-Stokes photons, one needs to take into account the photons that are extracted along the converter due to e.g. propagation losses and also the photons that are extracted at the front and the end of the converter. Since in this case the propagation losses are negligibly small and also the backscattering efficiency is considered to be negligible, the photon number ratio incorporating all Stokes and anti-Stokes photons is determined by FIG. 23 and is equal to 0.62 for a medium length of 0.68 m. The latter illustrates the possibilities for thermal controlling according to the embodiments of the present invention.

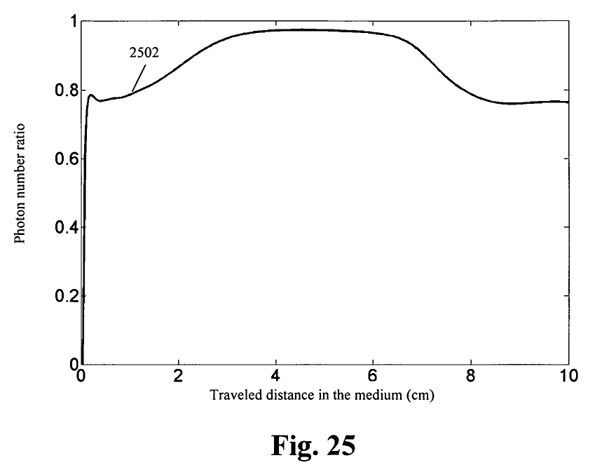

When performing the same optimizations as in the previous paragraph but this time for another Raman medium, it is possible to obtain an even higher photon number ratio for a converter setup. One can consider for example a silicon-based Raman converter, more specifically a silicon-on-insulator waveguide Raman converter. The phase mismatch of such a waveguide can be tuned by optimizing its geometrical configuration, so it is not necessary here to cross the directions of the pump and Stokes input beams for achieving a certain phase mismatch. The anti-Stokes Raman converter is excited by a pump pulse at 2.7 micron and a Stokes pulse at 3.14 micron, both with a pulse length of 7 ps. The wavelength of the generated anti-Stokes pulses is 2.37 micron. The Raman gain of the silicon waveguide for the material transition of 520 cm⁻¹ equals 1.6×10⁻⁸ cm/W and the collisional de-excitation time is 10 ps. The waveguide is 10 cm long and the propagation losses equal 1 dB/cm for all three wavelengths. The backscattering efficiency is considered to be negligibly small. The geometrical configuration of the waveguide is adapted such that a phase mismatch of 400 mrad/cm is obtained. This phase mismatch value is still relatively small in comparison with the phase mismatch that would exist in a bulk silicon medium without waveguide geometry. The pump laser of the Raman converter is a HF laser, the output beam of which is split up by a beamsplitter in a first beam that directly delivers the pump pulses to the anti-Stokes Raman converter, and in a second beam that passes through a Stokes seed generator to generate the Stokes input pulses for the anti-Stokes converter. The pump pulse has a maximum intensity of 25 GW/cm² and the maximum Stokes pulse intensity is 10⁻⁶*(25 GW/cm²)=25 kW/cm², which is a very small Stokes input intensity. The ratio 2502 of the total number of extracted anti-Stokes photons to the total number of extracted Stokes photons, calculated by the numerical single-pass transient model, evolves along the medium as shown in FIG. 25. The total extracted photon numbers for different positions in the converter comprise the photons that, in case the medium would be truncated at that position, would be extracted at the end of the converter and comprise also the photons that are extracted along the medium due to the propagation losses. Since the backscattering efficiency is considered to be negligibly small in this case, there is no extraction of photons at the front side of the converter. FIG. 25 shows that the best length optimization is to truncate the medium at a distance of 4.5 cm, where the photon number ratio reaches a maximum of 0.97. This very high value illustrates once again the possibilities for thermal controlling according to the embodiments of the present invention.

The examples provided illustrate that thermal control may be performed both using external parameters and internal parameters. Although the examples illustrate the latter for specific external parameters and specific internal parameters, all other external or internal parameters can be optimised in an analogous way.

1-21. (canceled)

22. A method for setting up a system comprising an active medium, the method comprising thermally controlling said system comprising an active medium by radiative cooling based on at least one of stimulated Raman scattering processes and coherent Raman scattering processes.

23. A method according to claim 22, wherein said system is defined by a number of system parameters, and wherein said thermally controlling comprises tailoring the efficiencies of said Raman scattering processes by optimising at least one of said number of system parameters.

24. A method according to claim 23, wherein said optimising at least one of said number of system parameters comprises selecting at least one of a parameter value and a parameter setting such that the ratio of the number of anti-Stokes Raman scattered photons to the number of Stokes Raman scattered photons is increased.

25. A method according to claim 23, wherein optimising at least one of said number of system parameters comprises:
obtaining at least one of a plurality of sets of system parameter values and system parameter settings;
for each of said plurality of sets of system parameter values and/or system parameter settings modelling optical processes including said Raman scattering processes in the active medium and calculating a number of Stokes- and anti-Stokes-scattered photons generated;
evaluating said plurality of calculated numbers of Stokes- and anti-Stokes-scattered photons generated and selecting, based thereon, at least one of a set of optimum system parameter values and system parameter settings.

26. A method according to claim 25, wherein said modelling optical processes comprises using a model describing a longitudinal variation of forward-propagating and backward-propagating pump, Stokes and anti-Stokes electromagnetic waves in said system and calculating a fraction of said forward- and backward-propagating pump, Stokes and anti-Stokes electromagnetic waves that is coupled out of said system.

27. A method according to claim 25, wherein said modelling optical processes comprises using a model allowing calculating a growth or decrease of Stokes pulses, of anti-Stokes pulses, and of the material excitation along the medium, while taking into account the pump pulse depletion.

28. A method according to claim 22 wherein thermally controlling comprises providing phase matching or quasi-perfect phase matching between different waves of radiation in the system comprising an active medium.

29. A method according to claim 22, wherein thermally controlling comprises selecting any or a combination of an active medium type, parameters of the active medium, and optical input parameters such that the scattering linewidth in the active medium is narrowed by a line narrowing effect and such that the pump can evoke a mechanism that adapts the material dispersion of the active medium.

30. A method according to claim 29, wherein the line narrowing effect is the Dicke line narrowing effect and wherein the mechanism that adapts the material dispersion of the active medium is electromagnetically induced transparency.

31. A method according to claim 22, wherein thermally controlling comprises adapting any or a combination of parameters of the pump radiation, parameters of the Stokes radiation, parameters of the anti-Stokes radiation, differences in phase between a pump input, at least one of a Stokes input and an anti-Stokes input, differences in polarisation between a pump input, at least one of a Stokes input and an anti-Stokes input, ratios between a pump input power, at least one of a Stokes input power and an anti-Stokes input power, angles between a pump input beam, at least one of a Stokes input beam and an anti-Stokes input beam, parameters of the active medium, parameters of the cavity mirrors, a distance or distances between cavity mirrors, an angle or angles between the optical axes of cavity mirror sets, a compensating phase-matching or quasi-perfect-phase-matching part with or next to the active medium, and pulse parameters in case of pulsed operation.

32. A system comprising an active medium for generating radiation, the system being adapted for being thermally controlled by radiative cooling based on at least one of coherent Raman scattering processes and stimulated Raman scattering processes.

33. A system according to claim 32, wherein said system is defined by a number of system parameters, and wherein efficiencies of said Raman scattering processes are tailored by selecting at least one of parameter values and parameter settings for said system parameters.

34. A system according to claim 33, wherein at least one of said selected parameter values and parameter settings is such that, in operation, the ratio of the number of anti-Stokes Raman scattered photons to the number of Stokes Raman scattered photons is increased.

35. A system according to claim 32, wherein said active medium is an undoped Raman-active medium or a doped medium with a Raman-active host.

36. A system according to claim 33, wherein said system parameters are any or a combination of parameters of the pump radiation, parameters of the Stokes radiation, parameters of the anti-Stokes radiation, differences in phase between a pump input, at least one of a Stokes input and an anti-Stokes input, differences in polarisation between a pump input, at least one of a Stokes input and an anti-Stokes input, ratios between a pump input power, at least one of a Stokes input power and an anti-Stokes input power, angles between a pump input beam, at least one of a Stokes input beam and an anti-Stokes input beam, parameters of the active medium, parameters of the cavity mirrors, a distance or distances between cavity mirrors, an angle or angles between the optical axes of cavity mirror sets, a compensating phase-matching or quasi-perfect-phase-matching part with or next to the active medium, and pulse parameters in case of pulsed operation.

37. A controller for controlling a system comprising an active medium for generating radiation according to claim 32.

38. A method for thermally controlling a system comprising an active medium for generating radiation, the method comprising:
providing generation of radiation and
controlling at least one of the efficiencies of coherent Raman scattering processes and stimulated Raman scattering processes during generation of radiation.

39. A method according to claim 38, wherein said controlling the efficiencies of said Raman scattering processes comprises controlling any or a combination of parameters of the pump radiation, parameters of the Stokes radiation, parameters of the anti-Stokes radiation, differences in phase between a pump input, at lest one of a Stokes input and an anti-Stokes input, differences in polarisation between a pump input, at least one of a Stokes input and an anti-Stokes input, ratios between a pump input power, at least one of a Stokes input power and an anti-Stokes input power, angles between a pump input beam, at least one of a Stokes input beam and an anti-Stokes input beam, parameters of the active medium, parameters of the cavity mirrors, a distance or distances between cavity mirrors, an angle or angles between the optical axes of cavity mirror sets, and pulse parameters in case of pulsed operation.
